(19) United States
(12) Patent Application Publication
(10) Pub. No.: US 2002/0111821 A1
(43) Pub. Date: Aug. 15, 2002

(54) Information provider device, information provider system and advertising method

(75) Inventor: Tatsuya Kunikiyo, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MITSUBISHI DENKI KABUSHIKI KAISHA, Chiyoda-ku (JP)

(21) Appl. No.: 09/961,146

(22) Filed: Sep. 24, 2001

(30) Foreign Application Priority Data
Feb. 14, 2001 (JP) 2001-036966

(51) Int. Cl. G06F 17/60

(52) U.S. Cl. 705/1

(57) ABSTRACT

A server or a standalone-type computer stores graphical information on a structure of a semiconductor device (CP1) and information on IP of function block or a semiconductor manufacturing apparatus (IF2) and outputs these informations linked to each other. Further, it is designed that an information terminal can access the server through a network to purchase the IP, a recipe of the semiconductor manufacturing apparatus, other softwares and the like through electronic commerce. Furthermore, an advertising agency operates the server and advertising expenditure and IP royalty are exchanged among a maker of semiconductor device, an IP vender and a vender of semiconductor manufacturing apparatus. Thus, an information provider device and an information provider system for providing the information on the structure of the semiconductor device and the information on design, which allows specific grasp of an image of applying the IP and the semiconductor manufacturing apparatus to actual manufacture of the semiconductor device, can be achieved, and an advertising method which ensures a high advertising effect can be provided.

### BACKGROUND OF THE INVENTION

1. Field of the Invention

The present invention relates to an information provider device and an information provider system which provide information on a structure of a semiconductor device, information on function blocks constituting the semiconductor device (i.e., information on IP (Intellectual Property) which is property on circuit design and the like) and information on semiconductor manufacturing apparatus used for manufacturing the semiconductor device, and further relates to an advertising method for making an advertisement on the IP and the semiconductor manufacturing apparatus.

2. Description of the Background Art

The growth in performance of manufacturing a semiconductor device is larger than that of designing the same and the performance difference tends to increase year after year. For example, the performance of manufacturing a semiconductor device is growing at a pace of about 58 percent a year in terms of the number of logic transistors. In contrast, the designer's performance of designing a semiconductor device (e.g., man-month performance of design, error correction and testing) is growing at a pace of about 25 percent or lower a year in terms of the number of logic transistors.

A system LSI is constituted of various types of function blocks, which requires long-time designing and verification, and this backgrounds such expansion of performance difference. Then, increase in the number of designers is required in order to compensate the expansion of performance difference and shorten the time period needed for introduction of the system LSI to the market.

As compared with the variety of types of system LSIs, however, it is not sufficient now to secure the number of designers. Therefore, it is becoming difficult to cover the design and verification of all the system LSIs by a company.

Then, in the design and verification of semiconductor devices, attempts to use IPs of other companies have been made. The IP is a general term which includes hardware such as circuit layouts and software written by circuit description language and further includes software used for core (mega cell), circuit library and microprocessor for integrated devices as designing properties for system LSI, and the like. Further, it may include software describing operating conditions of the semiconductor manufacturing apparatus used for manufacturing the semiconductor device. Furthermore, in the present invention, the semiconductor manufacturing apparatus itself is referred to as the IP of semiconductor manufacturing apparatus, which means a marketing right of the semiconductor manufacturing apparatus, in some cases.

The information on IPs is opened by IP venders (holders of IPs) on a communication network such as internet and available freely or for pay. Therefore, externally acquiring the IPs and designing own system LSI therewith allows improvement in efficiency.

Now, on the internet, an advertisement of IP information is made mainly by text, showing details on functions, structures and the like, as shown in FIG. 26. FIG. 26 shows an exemplary open specification list of IP #001 having memory macrocells and further having communications facility (communication function), graphics facility (function), mobile facility (function), computer and home electronics facility (function) and high-speed interface facility (function).

Further, an advertisement on the semiconductor manufacturing apparatus is also made by text, like the advertisement on IP information, showing details facilities (functions), constituent elements and the like.

Such disclosure of information made mainly by text, however, has difficulty in specific grasp of an image of applying the IP and the semiconductor manufacturing apparatus to actual manufacture of a semiconductor device. Specifically, it is difficult to grasp in what part of a semiconductor chip and how the IPs and the semiconductor manufacturing apparatus are actually used, how function blocks of the IPs are connected to one another on the chip and the like.

Further, when the maker of the semiconductor device buys IP, the maker highly regards whether the IP surely operates when mounted on the maker's semiconductor device as well as its function and price. In other words, since buyers of IPs want to examine the reliability of the IPs that they intend to buy, they want information such as what types of chips the IPs have been actually adopted to and how many actual adoption records the IPs have.

In such a case, when the IP vender discloses the information on its own IP mainly by text, the advertisement to makers of semiconductor devices produces low effect.

### SUMMARY OF THE INVENTION

The present invention is directed to an information provider device. According to a first aspect of the present invention, the information provider device comprises: memory means for recording structure information which is information of view on a structure of a semiconductor device in which at least one function block as a circuit block having a predetermined function is formed and function block information which is information on the function block; and control means for reading the structure information and the function block information out from the memory means and outputting these informations linked to each other.

According to a second aspect of the present invention, in the information provider device of the first aspect, the function block information includes information on intellectual property of the function block.

According to a third aspect of the present invention, in the information provider device of the second aspect, the function block information further includes information on advertisement of the intellectual property.

According to a fourth aspect of the present invention, in the information provider device of the first aspect, the structure information includes information on constituent elements constituting the semiconductor device, the function block information includes information on semiconductor manufacturing apparatus used for manufacturing the constituent elements, and the control means reads the structure information and the information on semiconductor manufacturing apparatus out from the memory means and outputs these informations linked to each other.

According to a fifth aspect of the present invention, in the information provider device of the fourth aspect, the information on semiconductor manufacturing apparatus includes information on advertisement of the semiconductor manufacturing apparatus.

According to a sixth aspect of the present invention, in the information provider device of the first aspect, the function block and the function block information each have hierarchical structure.

According to a seventh aspect of the present invention, in the information provider device of the sixth aspect, the function block information includes information on intellectual property of the function block or information on semiconductor manufacturing apparatus used for manufacturing constituent elements constituting the semiconductor device and information on advertisement of the intellectual property or the semiconductor manufacturing apparatus, and holders of the intellectual property in respective levels of the hierarchical structure or venders of the semiconductor manufacturing apparatus in respective levels of the hierarchical structure are different from one another.

The present invention is also directed to an information provider system. According to an eighth aspect of the present invention, the information provider system comprises: the information provider device of any one of the first to seventh aspects; and a first information terminal connectable to the information provider device through a network, and in the information provider system of the eighth aspect, the control means outputs the whole or part of the structure information to the first information terminal and outputs the function block information linked to the whole or part of the structure information to the first information terminal on request from the first information terminal.

According to a ninth aspect of the present invention, in the information provider system of the eighth aspect, the function block information includes information on intellectual property of the function block, the information provider device of the second aspect and the first information terminal each have electronic commerce function, and the information provider device conducts electronic commerce of intellectual property on the function block information with the first information terminal.

According to a tenth aspect of the present invention, in the information provider system of the ninth aspect, the first information terminal downloads software out of intellectual property on the function block information from the information provider device in the electronic commerce.

According to an eleventh aspect of the present invention, in the information provider system of the eighth aspect, the function block information includes information on semiconductor manufacturing apparatus used for manufacturing the constituent elements constituting the semiconductor device, the information provider device of the fourth aspect and the first information terminal each have electronic commerce function, and the information provider device conducts electronic commerce of the semiconductor manufacturing apparatus or information on the semiconductor manufacturing apparatus with the first information terminal.

According to a twelfth aspect of the present invention, in the information provider system of the eleventh aspect, the first information terminal downloads software on control of the semiconductor manufacturing apparatus out of information on the semiconductor manufacturing apparatus from the information provider device in the electronic commerce.

According to a thirteenth aspect of the present invention, in the information provider system of the eighth aspect, the control means retrieves the function block information with reference to recorded contents in the memory means on the basis of information transmitted from the first information terminal.

According to a fourteenth aspect of the present invention, the information provider system of the eighth aspect further comprises: a second information terminal connectable to the information provider device through a network, and in the information provider system of the fourteenth aspect, the function block information in the memory means is recorded on the basis of information transmitted from the second information terminal, and the control means modifies or deletes the function block information on request from the second information terminal.

The present invention is still directed to an advertising method. According to a fifteenth aspect of the present invention, the advertising method for making an advertisement uses the information provider device of the first aspect, and in the advertising method of the fifteenth aspect, the function block information includes information on intellectual property of the function block or information on semiconductor manufacturing apparatus used for manufacturing constituent elements constituting the semiconductor device, and the advertising method of the fifteenth aspect comprises the step of making an advertisement with the function block information including information on advertisement of the intellectual property or the semiconductor manufacturing apparatus.

According to a sixteenth aspect of the present invention, in the advertising method of the fifteenth aspect, the function block and the function block information each have hierarchical structure, and holders of the intellectual property in respective levels of the hierarchical structure or venders of the semiconductor manufacturing apparatus in respective levels of the hierarchical structure are different from one another.

According to a seventeenth aspect of the present invention, in the advertising method of the fifteenth or sixteenth aspect, the advertisement using the information provider device is made by a third party.

In the information provider device of the first aspect of the present invention, since the control means reads the structure information and the function block information out from the memory means and outputs these informations linked to each other, it is possible to display the views on a structure of a semiconductor device and the information on function blocks linked to each other on an output device. Therefore, an information provider device which allows easy grasp of relation between the structure of the semiconductor device and the information on function blocks can be obtained.

In the information provider device of the second aspect of the present invention, since the function block information includes the information on intellectual property (IP) of the function block, it is possible to display the views on the structure of the semiconductor device and the information on IP of the function block linked to each other on the output device. Therefore, an information provider device which allows easy grasp of an image of applying the IP of function blocks to actual manufacture of the semiconductor device can be obtained.

In the information provider device of the third aspect of the present invention, since the function block information further includes the information on advertisement of the intellectual property (IP), it is possible to display the views on the structure of the semiconductor device and the information on advertisement of the IP linked to each other on the output device. Therefore, an information provider device which ensures a high advertising effect on the IP of function blocks can be obtained.

In the information provider device of the fourth aspect of the present invention, since the control means reads the structure information and the information on semiconductor manufacturing apparatus out from the memory means and outputs these informations linked to each other, it is possible to display the structure information of the semiconductor device and the information on semiconductor manufacturing apparatus used for manufacturing the constituent elements linked to each other on the output device. Therefore, an information provider device which allows easy grasp of an image of applying the semiconductor manufacturing apparatus to actual manufacture of the semiconductor device can be obtained.

In the information provider device of the fifth aspect of the present invention, since the information on semiconductor manufacturing apparatus includes information on advertisement of the semiconductor manufacturing apparatus, it is possible to display the views on the structure of the semiconductor device and the information on advertisement of the semiconductor manufacturing apparatus linked to each other on the output device. Therefore, an information provider device which ensures a high advertising effect on the semiconductor manufacturing apparatus can be obtained.

In the information provider device of the sixth aspect of the present invention, since the function block and the function block information each have hierarchical structure, it is possible to obtain an information provider device which allows easy hierarchical grasp of relation between the structure of the semiconductor device and the information on the function blocks.

In the information provider device of the seventh aspect of the present invention, since the holders of the intellectual property in respective levels of the hierarchical structure or the venders of the semiconductor manufacturing apparatus in respective levels of the hierarchical structure are different from one another, the holder of the intellectual property or the vender of the semiconductor manufacturing apparatus in the lower level can display their own advertisements when the holder of the intellectual property or the vender of the semiconductor manufacturing apparatus in the upper level makes advertisements using the information provider device of the present invention. Therefore, the holder of the intellectual property or the vender of the semiconductor manufacturing apparatus in the lower level can make effective advertisements. Further, the holder of the intellectual property or the vender of the semiconductor manufacturing apparatus in the upper level can receive the advertising expenditure from the holder of the intellectual property or the vender of the semiconductor manufacturing apparatus in the lower level by incorporating the advertisements of the holder of the intellectual property or the vender of the semiconductor manufacturing apparatus in the lower level in their own advertisements.

In the information provider system of the eighth aspect of the present invention, since the control means outputs the whole or part of structure information to the first information terminal and outputs the function block information linked to the whole or part of structure information to the first information terminal on request from the first information terminal, it is possible to display the views on the structure of the semiconductor device and the information on the function blocks on the first information terminal on request from an operator of the first information terminal. Therefore, an information provider system which allows easy grasp of relation between the structure of the semiconductor device and the information on the function blocks for the operator of the first information terminal can be obtained.

In the information provider system of the ninth aspect of the present invention, since the information provider device conducts electronic commerce of intellectual property (IP) on the function block information with the first information terminal, it is possible to easily conduct the dealing of the IP on function block information.

In the information provider system of the tenth aspect of the present invention, since the first information terminal downloads software out of the IP on the function block information from the information provider device in the electronic commerce, it is possible to easily incorporate the software in a program on design of the semiconductor device made on the side of the first information terminal.

In the information provider system of the eleventh aspect of the present invention, since the information provider device conducts electronic commerce of the semiconductor manufacturing apparatus or information on the semiconductor manufacturing apparatus with the first information terminal, it is possible to easily conduct the dealing of the semiconductor manufacturing apparatus or the information on the semiconductor manufacturing apparatus.

In the information provider system of the twelfth aspect of the present invention, since the first information terminal downloads software on control of the semiconductor manufacturing apparatus out of information on the semiconductor manufacturing apparatus from the information provider device in the electronic commerce, it is possible to easily incorporate the software in a control program of the semiconductor manufacturing apparatus owned on the side of the first information terminal.

In the information provider system of the thirteenth aspect of the present invention, since the control means retrieves the function block information with reference to recorded contents in the memory means on the basis of information transmitted from the first information terminal, the operator of the first information terminal can access desired function block information.

In the information provider system of the fourteenth aspect of the present invention, since the function block information in the memory means is recorded on the basis of information transmitted from the second information terminal and the control means modifies or deletes the function block information on request from the second information terminal, an operator of the second information terminal can easily register, modify and delete his own function block information.

In the advertising method of the fifteenth aspect of the present invention, since the function block information includes the information on intellectual property (IP) of the function block or the information on semiconductor manufacturing apparatus used for manufacturing constituent elements constituting the semiconductor device and the advertisement is made with the function block information including the information on advertisement of the IP or the semiconductor manufacturing apparatus, customers can specifically grasp the actual adoption record of the IP or the semiconductor manufacturing apparatus to the semiconductor device and a highly effective advertising method can be achieved.

In the advertising method of the sixteenth aspect of the present invention, since the holders of the intellectual property in respective levels of the hierarchical structure or the venders of the semiconductor manufacturing apparatus in respective levels of the hierarchical structure are different from one another, the holder of the intellectual property or the vender of the semiconductor manufacturing apparatus in the lower level can display their own advertisements when the holder of the intellectual property or the vender of the semiconductor manufacturing apparatus in the upper level makes advertisements using the advertising method of the present invention. Therefore, the holder of the intellectual property or the vender of the semiconductor manufacturing apparatus in the lower level can make effective advertisements. Further, the holder of the intellectual property or the vender of the semiconductor manufacturing apparatus in the upper level can receive the advertising expenditure from the holder of the intellectual property or the vender of the semiconductor manufacturing apparatus in the lower level by incorporating the advertisements of the holder of the intellectual property or the vender of the semiconductor manufacturing apparatus in the lower level in their own advertisements.

In the advertising method of the seventeenth aspect of the present invention, since the advertisement using the information provider device is made by a third party, the third party operating the information provider device collects the value for the advertisement of the adopted intellectual property or semiconductor manufacturing apparatus and the maker of the semiconductor device can receive the value in a unified way. Further, the maker can make advertisement on its own semiconductor device without installing the information provider device.

An object of the present invention is to achieve an information provider device and an information provider system capable of providing such information on a structure of a semiconductor device and information on function blocks constituting the semiconductor device as can give specific grasp of an image of applying IPs and semiconductor manufacturing apparatus to actual manufacture of the semiconductor device, and to provide a highly effective advertising method.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1 to 10 are views showing examples of screen display on an information provider device in accordance with a first preferred embodiment of the present invention;

FIG. 11 is a view used for discussing an advertising method in accordance with a second preferred embodiment of the present invention, showing a relation of property rights on function blocks of a semiconductor device;

FIGS. 12 and 13 are views showing flows of advertising expenditure and IP royalty in the advertising method in accordance with the second preferred embodiment of the present invention;

FIG. 14 is a view showing an information provider system in accordance with a third preferred embodiment of the present invention;

FIG. 15 is a view showing a constitution of a server in the information provider system in accordance with the third preferred embodiment of the present invention;

FIGS. 16 to 25 are views showing a procedure in the information provider system in accordance with the third preferred embodiment of the present invention; and

FIG. 26 is a view showing an advertisement of IP in the background art.

### DESCRIPTION OF THE PREFERRED EMBODIMENTS

<The First Preferred Embodiment>

The first preferred embodiment is intended to achieve an information provider device which allows easy grasp of an image of applying IPs and semiconductor manufacturing apparatus to actual manufacture of a semiconductor device by recording graphic information on a structure of the semiconductor device and information on function blocks constituting the semiconductor device and outputting these informations linked to each other.

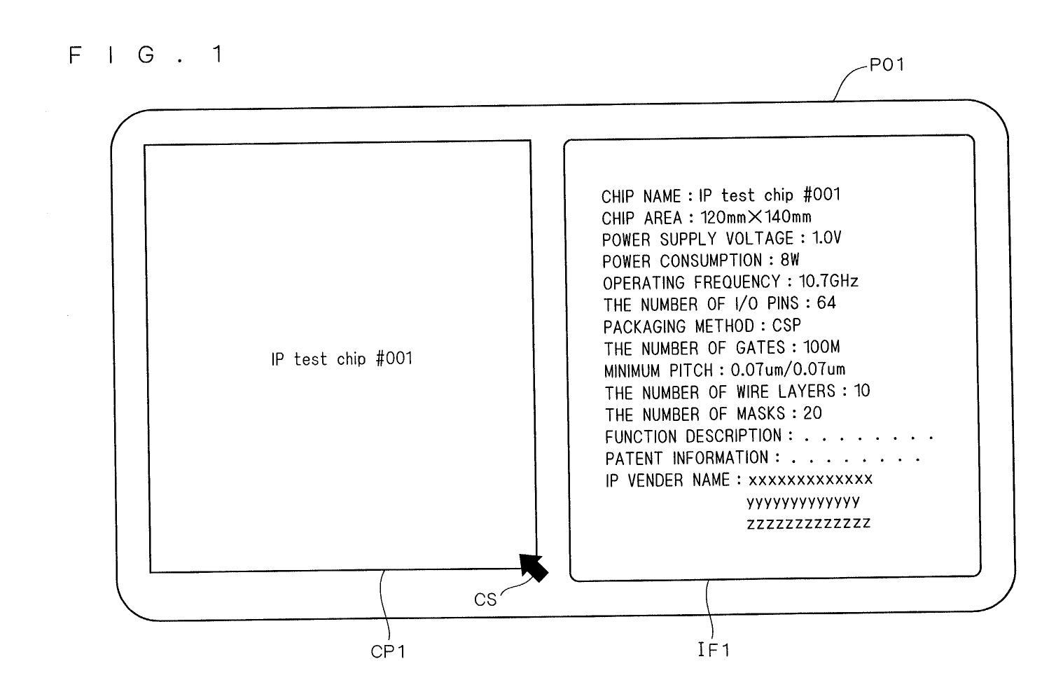

FIGS. 1 to 10 are views showing examples of display screen on an information provider device in accordance with the first preferred embodiment of the present invention. Further, a constitution of the information provider device of the first preferred embodiment will be specifically described in the third preferred embodiment.

The information provider device of the first preferred embodiment records information on a structure of the semiconductor device (referred to as structure information in the present invention) such as a plan view, a circuit diagram and a pattern layout diagram and information on function blocks (information on IPs and semiconductor manufacturing apparatus, referred to as function block information in the present invention) adopted in the semiconductor device. The structure information is outputted from the information provider device and displayed on an output device. The function block information is also outputted, being linked to the structure information, and displayed on the output device.

Further, when the function block in the semiconductor device has a hierarchical structure, including lower-leveled function blocks, the function block information in each level is linked to the structure information and outputted from the information provider device of the first preferred embodiment at every tracing the hierarchical level.

FIG. 1 is a display screen P01 showing an exemplary screen display on an output device in a case where a plan view of a semiconductor device CP1 named IP test chip #001 is outputted as structure information from the information provider device. In the display screen P01, as an example, the plan view of the semiconductor device CP1 is shown on the left hand of the screen. Further, in the display screen P01 also shown is a cursor CS which can be operated by an operator who gives instructions to the information provider device.

In the display screen P01, when the operator operates an input device such as a mouse to move the cursor CS onto the plan view of the semiconductor device CP1, for example, information IF1 on the semiconductor device CP1 is outputted from the information provider device. The above description “the function block information is outputted, being linked to the structure information” means that the function block information is outputted, accompanying the structure information, when a procedure is thus performed on the structure information. Further, in the display screen P01, as an example, the information IF1 on the semiconductor device CP1 is shown on the right hand of the screen.

The information IF1 includes the chip name, the chip area, the power supply voltage, the power consumption, the operating frequency, the number of I/O pins, the packaging method, the number of gates, the minimum pitch, the number of wire layers, the number of masks, the function description, the patent information, the vender's name of the adopted IP and the like of the semiconductor device CP1, as an example. Further, as to the minimum pitch, the width of wire is shown on the left hand and the distance between wires is shown on the right hand.

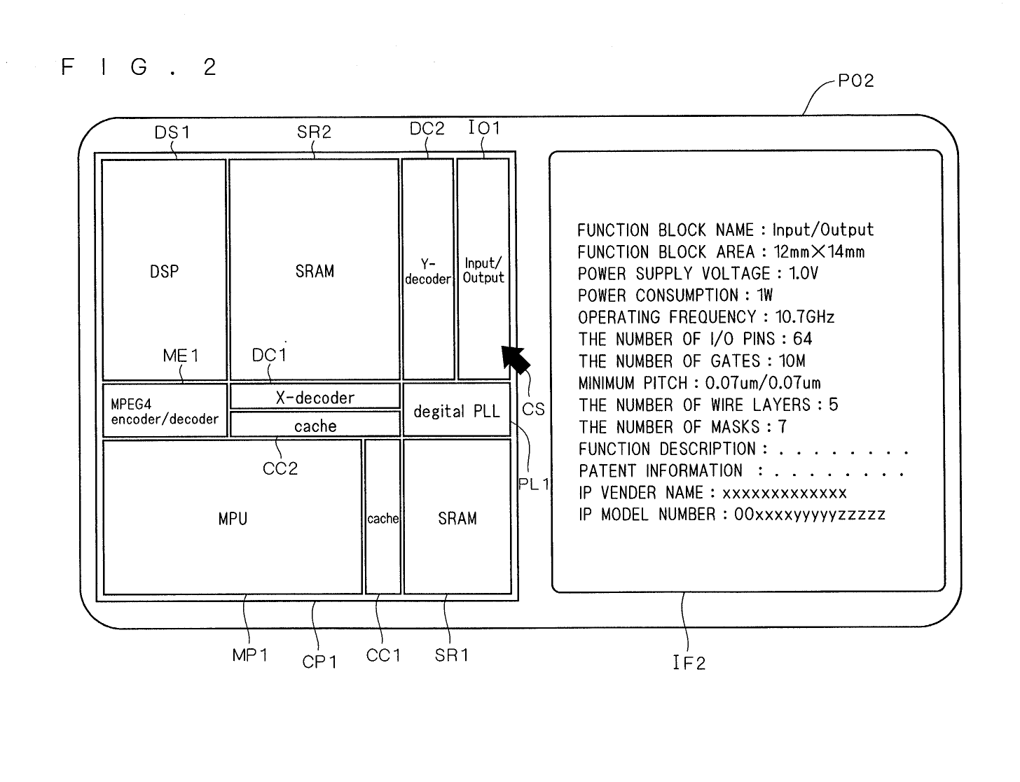

Now, it is designed that if the cursor CS is placed on the plan view of the semiconductor device CP1, when the operator clicks the mouse, the function blocks formed in the semiconductor device CP1 will be displayed as shown in a display screen P02 of FIG. 2. Further, if the figures are displayed in windows form, the display screen P02 of FIG. 2 may overlap inside the display window of the display screen P01 and may be displayed in another display window.

The display screen P02 shows a case where a DSP (Digital Signal Processing) unit DS1, SRAM (Static Random Access Memory) units SR1 and SR2, cache memories CC1, CC2, decoders DC1 and DC2, an MPU (Micro Processing Unit) MP1, an MPEG (Motion Picture Experts Group) encoder/decoder ME1, a PLL (Phase Locked Loop) unit PL1 and an I/O (Input/Output) interface unit IO1 are formed in the semiconductor device CP1. As a matter of course, the function blocks shown in FIG. 2 are examples and function blocks formed in the semiconductor device CP1 are not limited to these.

Now, in the display screen P02, when the operator operates the input device such as a mouse to move the cursor CS onto the I/O interface unit IO1, for example, information IF2 on the I/O interface unit IO1 is outputted from the information provider device.

The information IF2 includes the function block name, the function block area, the power supply voltage, the power consumption, the operating frequency, the number of I/O pins, the number of gates, the minimum pitch, the number of wires, the number of masks, the function description, the patent information, the vender's name of the adopted IP and the model number of the IP of the I/O interface unit 101, as an example. Further, the information IF2 may further include information on advertisement of the function block as discussed in the third preferred embodiment.

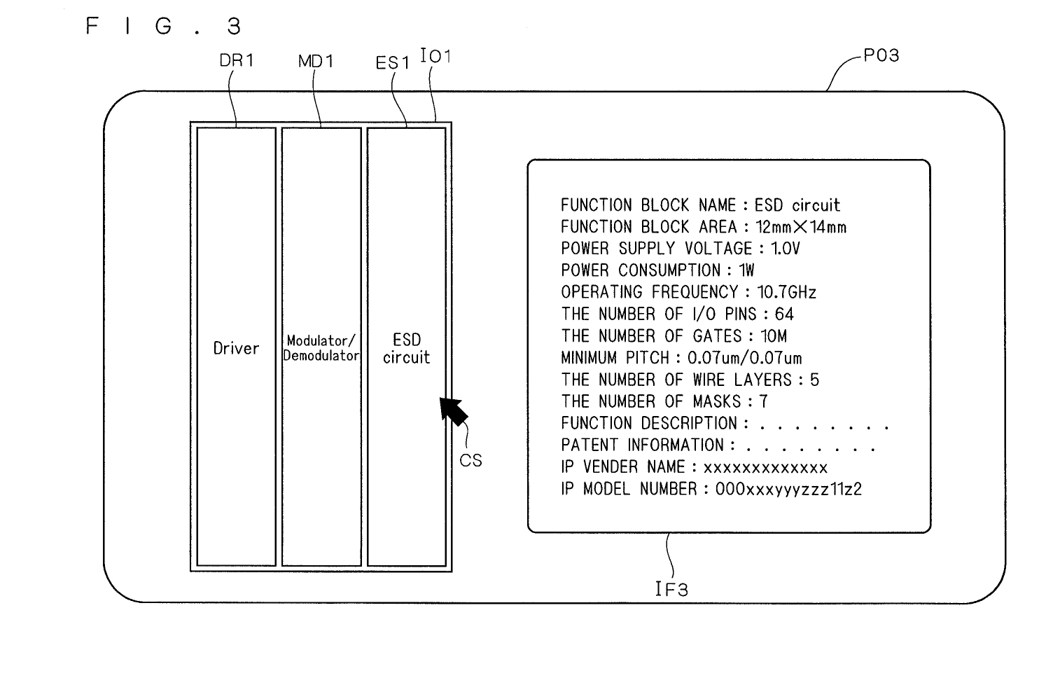

Further, it is designed that if the cursor CS is placed on the I/O interface unit IO1, when the operator clicks the mouse, the function blocks of lower level included in the I/O interface unit IO1 will be displayed as shown in a display screen P03 of FIG. 3. Specifically, it is designed that a driver DR1, a modem MD1 and an ESD (Electro-Static Discharge) circuit ES1 included in the I/O interface unit IO1 will be displayed. As a matter of course, the function blocks shown in FIG. 3 are examples and function blocks formed in the I/O interface unit IO1 are not limited to these.

In the display screen P03, when the operator operates the input device such as a mouse to move the cursor CS onto the ESD circuit ES1 for keeping the voltage at a constant value, for example, information IF3 on the ESD circuit ES1 is outputted from the information provider device.

The information IF3 includes the function block name, the function block area, the power supply voltage, the power consumption, the operating frequency, the number of I/O pins, the number of gates, the minimum pitch, the number of wire layers, the number of masks, the function description, the patent information, the vender's name of the adopted IP, the model number of the IP and the like of the ESD circuit ES1, as an example.

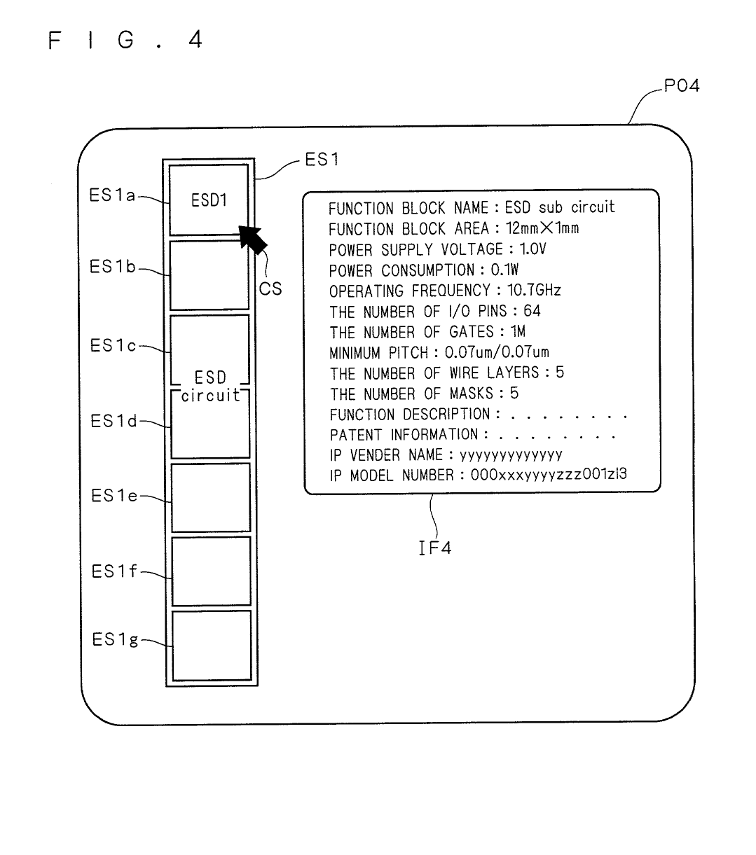

Further, it is designed that if the cursor CS is placed on the ESD circuit ES1, when the operator clicks the mouse, the function blocks of lower level included in the ESD circuit ES1 will be displayed as shown in a display screen P04 of FIG. 4. Specifically, it is designed that ESD sub-circuits ES1a to ES1g included in the ESD circuit ES1 will be displayed. As a matter of course, the function blocks shown in FIG. 4 are examples and function blocks formed in the ESD circuit ES1 are not limited to these.

In the display screen P04, when the operator operates the input device such as a mouse to move the cursor CS onto the ESD sub-circuit ES1a, for example, information IF4 on the ESD sub-circuit ES1a is outputted from the information provider device.

The information IF4 includes the function block name, the function block area, the power supply voltage, the power consumption, the operating frequency, the number of I/O pins, the number of gates, the minimum pitch, the number of wire layers, the number of masks, the function description, the patent information, the vender's name of the adopted IP, the model number of the IP and the like of the ESD sub-circuit ES1a, as an example.

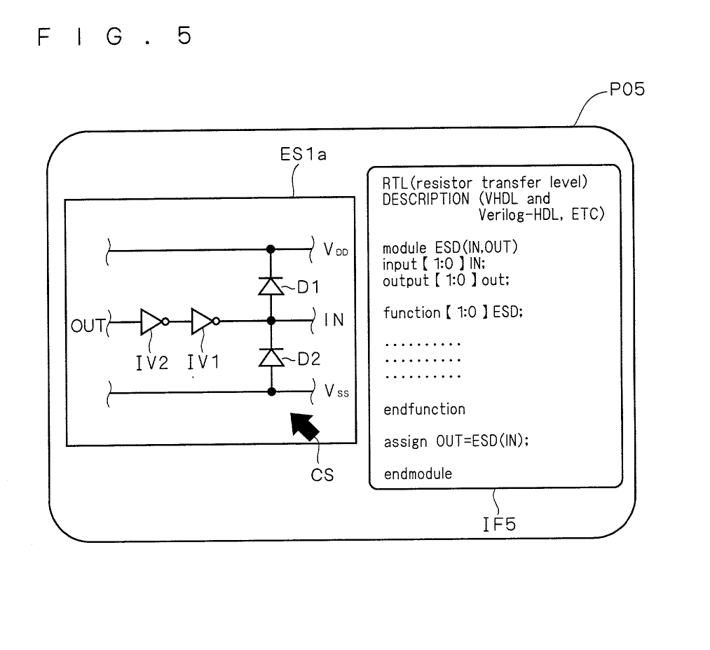

Further, it is designed that if the cursor CS is placed on the ESD sub-circuit ES1a, when the operator clicks the mouse, the function blocks of lower level included in the ESD sub-circuit ES1a will be displayed as shown in a display screen P05 of FIG. 5. Specifically, it is designed that inverters IV1 and IV2 and diodes D1 and D2 constituting the ESD sub-circuit ES1a and a circuit diagram showing their interconnection, input/output, applied voltage and the like will be displayed. As a matter of course, the function blocks shown in FIG. 5 are examples and function blocks formed in the ESD sub-circuit ES1a are not limited to these. Further, a logic circuit element such as an inverter, a circuit element such as a diode and a wire are also regarded as kinds of function blocks.

In the display screen P05, when the operator operates the input device such as a mouse to move the cursor CS onto the ESD sub-circuit ES1a in a circuit diagram, for example, information IF5 on a circuit diagram of the ESD sub-circuit ES1a is outputted from the information provider device.

The information IF5 includes information of a source program written by the RTL (Resistor Transfer Level) circuit description language (VHDL, Verilog-HDL and the like), describing a configuration of the ESD sub-circuit ES1a, as an example. Further, though not shown, the information IF5 may include information on a simulation result and a measured result and the like in the timing chart of input/output waveforms of the ESD sub-circuit ES1a as well as the source program.

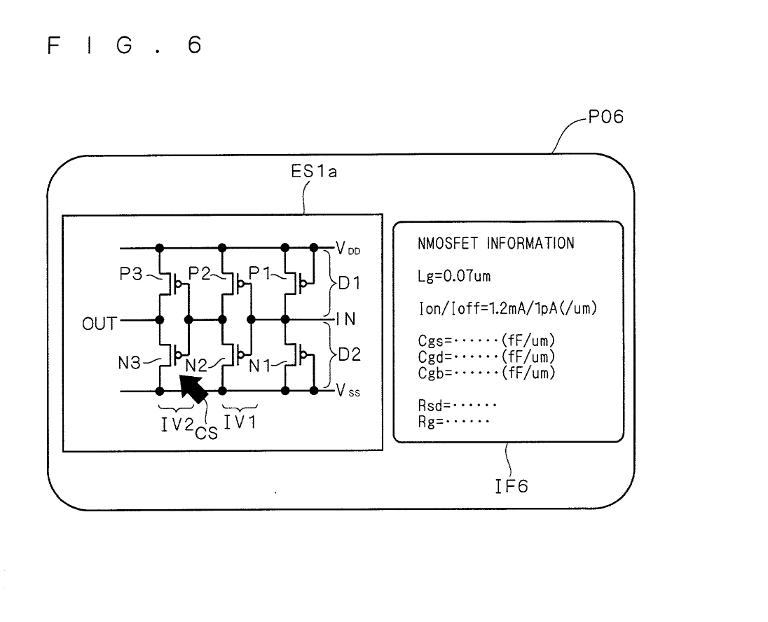

Further, it is designed that if the cursor CS is placed on the circuit diagram of the ESD sub-circuit ES1a, when the operator clicks the mouse, the function blocks of lower level included in the circuit elements of the ESD sub-circuit ES1a will be displayed as shown in a display screen P06 of FIG. 6. Specifically, it is designed that Nch-MOS transistors N1 to N3 and Pch-MOS transistors P1 to P3 constituting the inverters IV1 and IV2 and diodes D1 and D2 and a circuit diagram showing their interconnection, input/output, applied voltage and the like will be displayed. As a matter of course, the function blocks shown in FIG. 6 are examples and function blocks formed in the inverters IV1 and IV2 and the diodes D1 and D2 are not limited to these. Further, a circuit element such as a transistor and a wire are also regarded as kinds of function blocks.

In the display screen P06, when the operator operates the input device such as a mouse to move the cursor CS onto the Nch-MOS transistor N3, for example, information IF6 on the Nch-MOS transistor N3 is outputted from the information provider device.

The information IF6 includes information on the gate length Lg, the drain-source current of ON/OFF times Ion/Ioff, the gate-source static capacitance Cgs, the gate-drain static capacitance Cgd, the gate-body static capacitance Cgb, the drain-source resistance Rsd, the gate resistance Rg and the like of the Nch-MOS transistor N3, as an example. Further, though not shown, the information IF6 may include information on a program for circuit simulation of a transistor (h-spice and the like) and its simulation result (timing chart of input/output waveforms and the like) and a measured result of the input/output waveforms, and the like as well as the information on the circuit element such as the transistor.

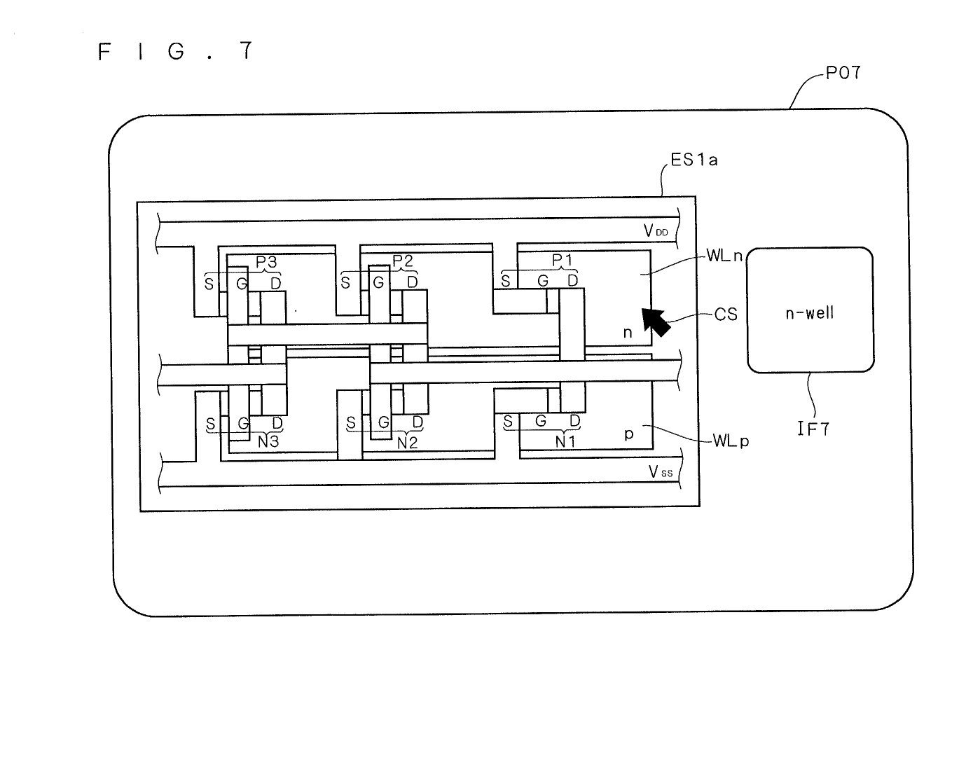

Further, it is designed that if the cursor CS is placed on the circuit diagram of the ESD sub-circuit ES1a in transistor level, when the operator clicks the mouse, the function blocks will be displayed in pattern layout diagram as shown in a display screen P07 of FIG. 7. Specifically, it is designed that the Nch-MOS transistors N1 to N3 and the Pch-MOS transistors P1 to P3 and the pattern layout diagram showing their interconnection, input/output, applied voltage and the like will be displayed. As a matter of course, the pattern layout shown in FIG. 7 is an example and the pattern layout of the transistors and interconnection are not limited to these. Further, a circuit element such as a transistor in pattern layout diagram and a wire are also regarded as kinds of function blocks.

In the display screen P07, when the operator operates the input device such as a mouse to move the cursor CS onto an N well region WLn in the pattern layout, for example, information IF7 on the N well region WLn is outputted from the information provider device.

The information IF7 includes information indicating an N well, as an example. Further, though not shown, the information IF7 may include information on OPC (Optical Proximity Correction) and deformed illumination in a transfer process, an optical simulation result (finish layout pattern after the transfer process) such as phase shift, and the like as well as the information on the pattern layout.

In the information provider device of the first preferred embodiment, since the structure information of the semiconductor device and the function block information are outputted, being linked to each other, it is possible to display the views on the structure of the semiconductor device and the information on the function blocks linked to each other on an output device. Therefore, the relation between the structure of the semiconductor device and the information on the function blocks can be easily grasped.

Further, when the function block information includes the information on IP of the function blocks, it is possible to display the views on the structure of the semiconductor device and the information on the IP of the function blocks linked to each other on the output device. Therefore, the image of applying the IP of function blocks to actual manufacture of the semiconductor device can be easily grasped.

Furthermore, when the function block information further includes the information on an advertisement of the function blocks, it is possible to display the views on the structure of the semiconductor device and the information on the advertisement of the function blocks linked to each other on the output device. Therefore, an information provider device which ensures a high advertising effect on the IP of function blocks can be obtained.

Further, in the information provider device of the first preferred embodiment, since the function block includes other function blocks and the whole or part of structure information and the function block information on other function blocks are outputted, being linked to each other, such as the relation of the ESD circuit ES1 to the I/O interface unit IO1, it is possible to display the views on the structure of the semiconductor device and the information on other function blocks linked to each other on the output device. Therefore, the relation between the structure of the semiconductor device and the information on the function blocks can be hierarchically grasped.

Though the case where the plan view, the circuit diagram and the pattern layout diagram of the semiconductor device are adopted as the structure information is discussed above, a cross section of the semiconductor device may be adopted as the structure information. Further, it is only necessary to output information on a semiconductor manufacturing apparatus used for manufacturing the semiconductor device, together with the information of cross section.

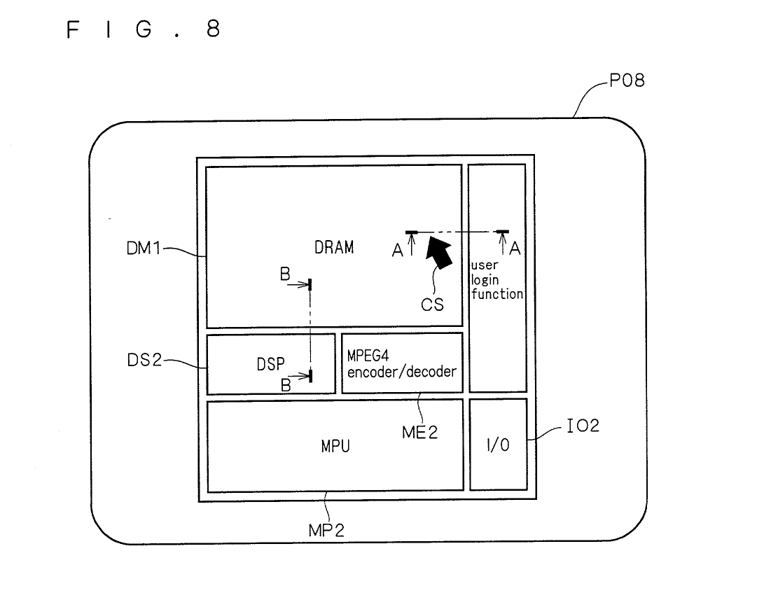

FIG. 8 is a display screen P08 showing an exemplary screen display on an output device in a case where a plan view of a semiconductor device CP2 is outputted as structure information from the information provider device. In the plan view of the semiconductor device CP2, section lines A-A and B-B are shown. Further, in the display screen P08 also shown is a cursor CS which can be operated by an operator who gives instructions to the information provider device.

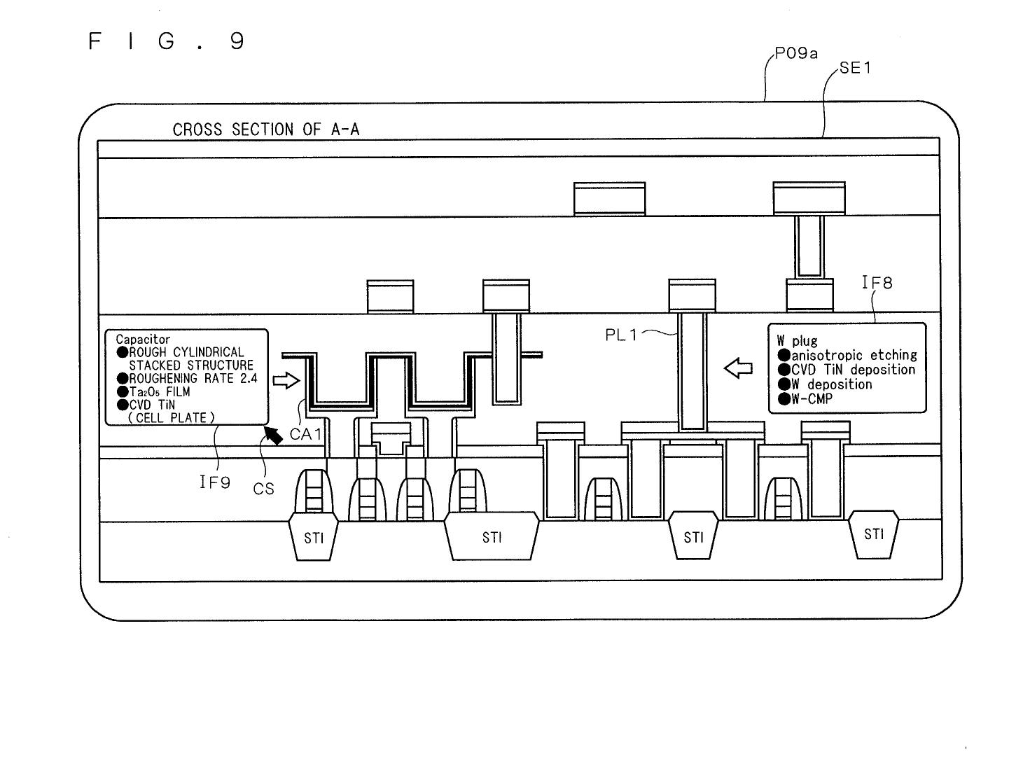

In the display screen P08, when the operator operates the input device such as mouse to move the cursor CS onto the section line, for example, a display screen P09a of a cross section SE1 taken along the section line of the semiconductor device CP2 is outputted from the information provider device, as shown in FIG. 9.

The cross section SE1 shows a capacitor CA1, a contact plug PL1 and the like which are constituent elements of the semiconductor device CP2 as an example, and further includes informations IF8 and IF9 on these constituent elements. Further, the informations on the constituent elements include information of materials of the constituent elements, information of manufacturing process, and the like.

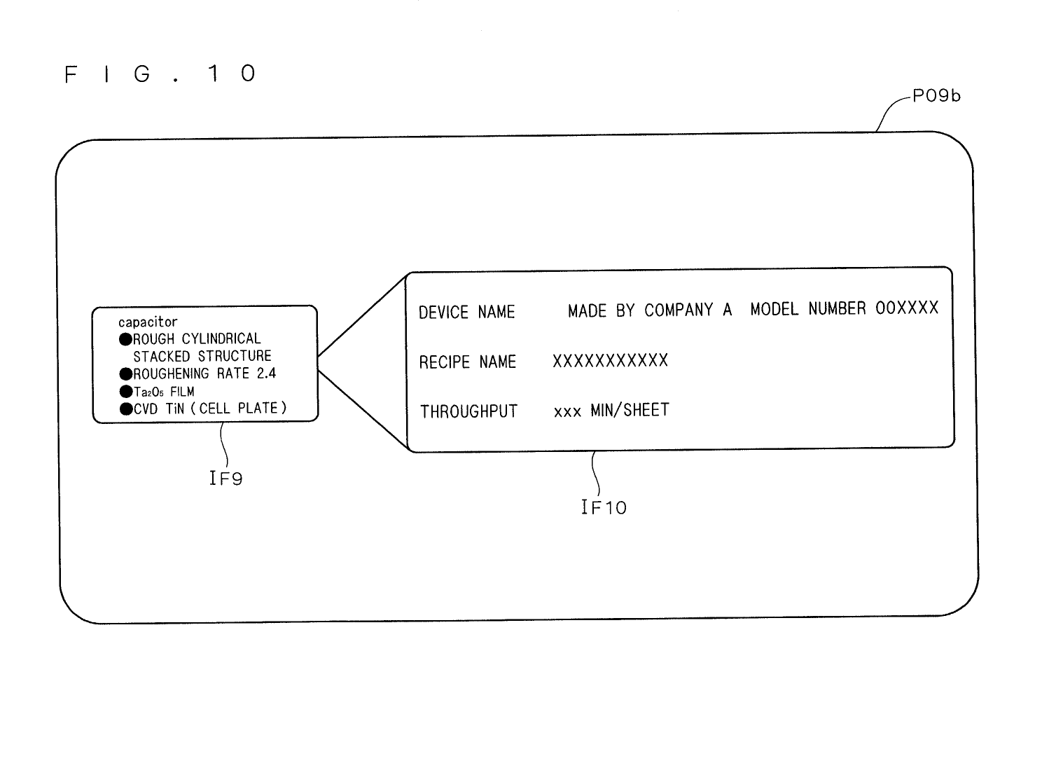

Now, in the display screen P09a, when the operator operates the input device such as a mouse to move the cursor CS onto the information IF 9 on the capacitor CA1, for example, information IF10 on a semiconductor manufacturing apparatus used for manufacturing the capacitor CA1 is outputted from the information provider device, as shown in the display screen P09b of FIG. 10. Further, the information IF10 on the semiconductor manufacturing apparatus is also stored in the information provider device of the first preferred embodiment in advance.

The information IF 10 includes device information such as the device name, the recipe name and the throughput, as an example. The recipe refers to a processing program on control sequence of manufacturing apparatus and the like. The information IF10 may further include information on advertisement of the semiconductor manufacturing apparatus as discussed in the third preferred embodiment.

Thus, when the information of the cross section and the information on the semiconductor manufacturing apparatus are outputted, being linked to each other, it is possible to display the cross section of the semiconductor device and the information on the semiconductor manufacturing apparatus used for manufacturing the constituent elements of the semiconductor device linked to each other on the output device. Therefore, an information provider device allows easy grasp of an image of applying the semiconductor manufacturing apparatus to actual manufacture of the semiconductor device can be obtained.

Further, when the information on the semiconductor manufacturing apparatus includes the information on the advertisement of the semiconductor manufacturing apparatus, it is possible to display the views on the structure of the semiconductor device and the information on the advertisement of the semiconductor manufacturing apparatus linked to each other on the output device. Therefore, an information provider device which ensures a high advertising effect on the semiconductor manufacturing apparatus can be obtained.

Furthermore, the information provider device of the first preferred embodiment may be installed as a standalone type, for example, and may be installed as a server on a network as discussed in the third preferred embodiment.

<The Second Preferred Embodiment>

The second preferred embodiment is directed to a method of making an advertisement of IPs of the function blocks adopted in the semiconductor device, using the information provider device of the first preferred embodiment, in which advertising expenditure and IP royalty are paid between those who sets up the information provider device and holders of IPs of the function blocks.

IP venders have the need of advertising their own IPs to a lot of makers of semiconductor device and promoting the sales of the IPs. Then, as a method of advertisement, there is an idea of displaying a semiconductor device which adopts the IPs to other makers of semiconductor device for introduction of mount conditions. No advertising method like this has been conventionally considered.

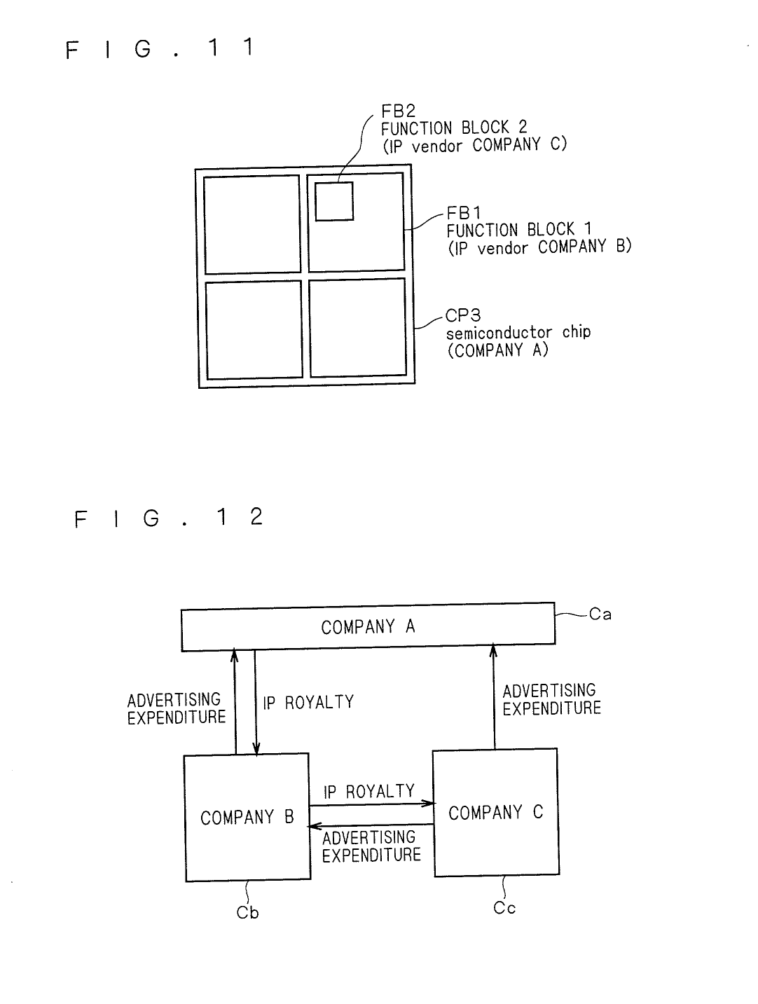

An advertising method of the second preferred embodiment will be discussed below, referring to FIGS. 11 to 13. Discussion will be made on a case, as shown in FIG. 11, where a semiconductor device CP3 manufactured by a company A adopts a function block FB1 of an IP vender, company B and the function block FB1 adopts a function block FB2 of an IP vender, company C, as an example.

When the company A, the maker of semiconductor device, advertises a semiconductor device adopting only its own IP using the information provider device of the first preferred embodiment, the company A gains no advertising income.

When the company A adopts the IP of the function block FB1 of the company B, the IP vender, however, if the company B makes an advertisement of its own function block FB1 through an advertisement of the semiconductor device provided by the information provider device installed by the company A by incorporating the advertisement of the function block in the function block information, the company A gains the advertising income from the company B while the company B can show such a highly effective advertisement as the customers can specifically grasp the actual adoption record of its own IP to the semiconductor device to other makers of semiconductor device.

Further, the company C having the IP of the function block FB2 can also show such a highly effective advertisement as the customers can specifically grasp the actual adoption record of its own IP to the semiconductor device to other makers of semiconductor device by paying the advertising expenditure to the companies A and B.

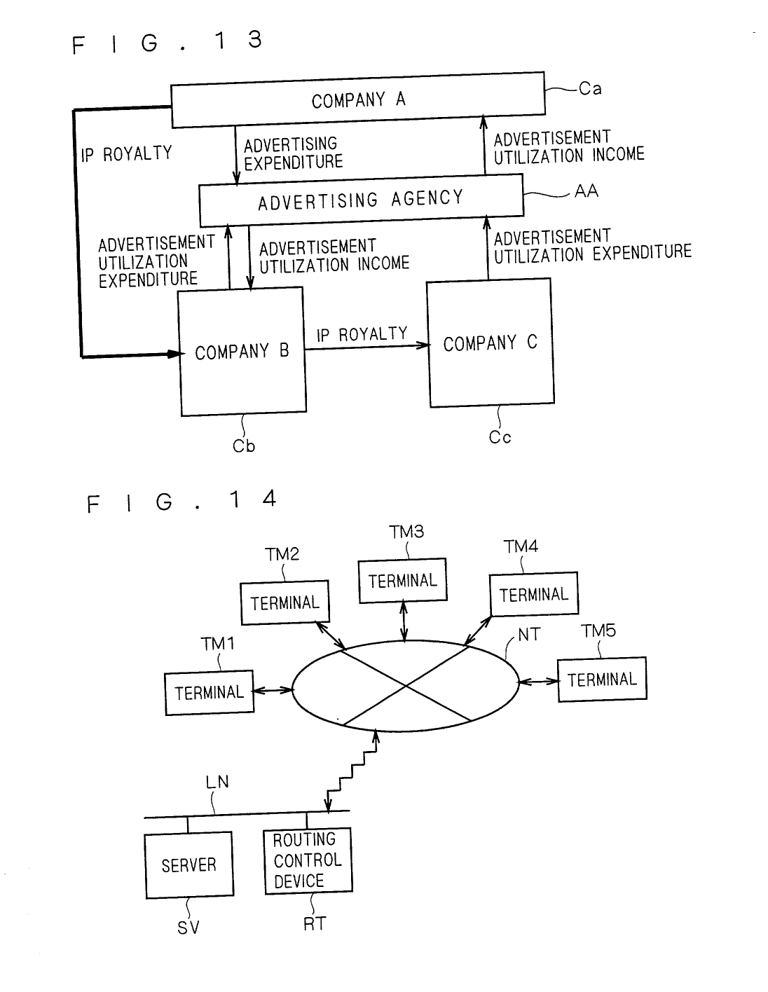

FIG. 12 is a schematic view on the above discussion, showing the flows of advertising expenditure and IP royalty among the three companies, i.e., the company A Ca, the company B Cb and the company C Cc. When both the companies B Cb and C Cc make advertisements through the information provider device of the company A, the company B Cb pays the advertising expenditure to the company A Ca while the company B Cb receives the IP royalty from the company A Ca, and further the company C Cc pays the advertising expenditure to the companies A Ca and B Cb while the company C Cc receives the IP royalty from the company B Cb.

If the company C does not intend to make an advertisement, it is designed that only the function block information on the part of the function block FB1 developed by the company B can be displayed on the information provider device of the first preferred embodiment and the function block information of the function block FB2 can not be displayed. In this case, the company C does not need to pay the advertising expenditure.

Further, if the company B does not intend to make an advertisement, it is designed that only the function block information on the part of the function block FB1 developed by the company B can not be displayed on the information provider device of the first preferred embodiment and the function block information of the function block FB2 can be displayed. In this case, the company B does not need to pay the advertising expenditure. The company C pays the advertising expenditure only to the company A.

The company A, the maker of semiconductor device, can substantially reduce the IP royalty by the advertising income. Further, the companies B and C, the IP venders, can show a highly effective advertisement to other makers of semiconductor device since the advertisement of their own IPs can be made through the semiconductor device made by the company A.

FIG. 13 shows another example in the case where both the companies B and C make advertisements through the information provider device of the first preferred embodiment. FIG. 13 is different from FIG. 12 in that the advertisements are made through an advertising agency AA.

The advertising agency AA installs the information provider device of the first preferred embodiment and has an agential function of collecting and paying the advertising expenditure and the advertisement utilization expenditure. The company A Ca pays the advertising expenditure to the advertising agency AA since the advertising agency AA undertakes the agency for the advertisement of the semiconductor device made by the company A Ca.

Further, the company B Cb pays the advertisement utilization expenditure for the company A Ca to the advertising agency AA since the company B Cb makes an advertisement utilizing the semiconductor device of the company A Ca. The advertisement utilization expenditure taken from the company B Cb is paid to the company A Ca through the advertising agency AA. In other words, the company A Ca gains an advertisement utilization income.

Furthermore, the company C Cc pays the advertisement utilization expenditure for the companies A Ca and B Cb to the advertising agency AA since the company C Cc makes an advertisement utilizing the semiconductor device of the company A Ca and the function block FB1 of the company B Cb. The advertisement utilization expenditure taken from the company C Cc is paid to the companies A Ca and B Cb through the advertising agency AA. In other words, the companies A Ca and B Cb gain advertisement utilization incomes.

The advertising agency AA gains a predetermined rate of the advertising expenditure and the advertisement utilization expenditure from the companies A Ca, B Cb and C Cc as commission.

Though the above case is an advertisement of IP, the same applies to an advertisement of a semiconductor manufacturing apparatus. Specifically, in FIGS. 11 to 13, assuming that the companies B and C are venders of semiconductor manufacturing apparatus instead of the IP venders and the IP royalty is replaced by the value of the semiconductor manufacturing apparatus (value of the semiconductor manufacturing apparatus itself, value of recipe and other softwares for controlling the apparatus), and the semiconductor manufacturing apparatus of the company B is adopted in the function block FB1 and the semiconductor manufacturing apparatus of the company C is adopted in the function block FB2, the same flows of values can be applied to the advertisement of the semiconductor manufacturing apparatus.

Using the second preferred embodiment, acquired is such a highly effective advertising method as customers can specifically grasp the actual adoption record of the IPs or the semiconductor manufacturing apparatus to the semiconductor device.

Further, when the advertising agency intervenes, the whole or part of values for the advertisement taken from the IP venders or the venders of the semiconductor manufacturing apparatus are paid to the maker of semiconductor device through the advertising agency that installs the information provider device and the advertising agency receives the value for the advertisement of the semiconductor device from the maker of semiconductor device, and therefore the maker of semiconductor device can receive the values for the advertisement of the adopted IPs or semiconductor manufacturing apparatus in a unified way from the advertising agency. Further, the maker of semiconductor device can advertise its own semiconductor device without installing the information provider device.

<The Third Preferred Embodiment>

The third preferred embodiment is intended to realize an information provider system by using the information provider device of the first preferred embodiment as a server on a network which is operated by the advertising agency discussed in the second preferred embodiment. The information provider system allows the information on the semiconductor device, the IP information and the information of the semiconductor manufacturing apparatus to be read and retrieved by the general public and allows registration, modification and deletion of these information, and also achieves an electronic commerce of the IPs and the semiconductor manufacturing apparatus.

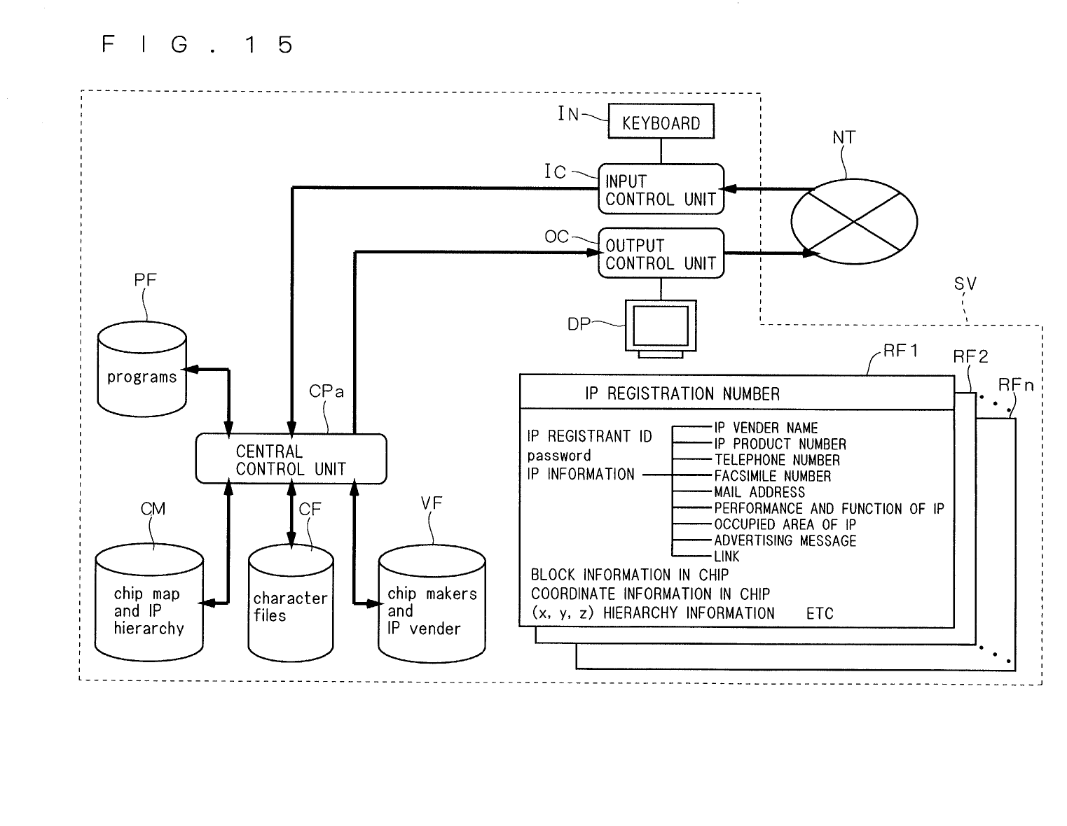

A constitution of the information provider system of the third preferred embodiment is shown in FIG. 14. In FIG. 14, information terminals TM1 to TM5 are each connected to a network NT. Further, a routing control device RT connected to the network NT is connected to a server SV through a local area network LN.

The information terminals TM1 to TM5 correspond to a variety of information terminals such as a desktop computer, a notebook computer, a palmtop computer, a cellular phone, a BS digital television and a videophone, and each comprise a display unit for displaying information and an input unit such as a keyboard, a mouse and an input pen.

Further, though the network NT connecting the server SV and the information terminals TM1 to TM5 is assumed to be an internet, it may be a wide area network (WAN) and the like. Furthermore, as to the communication line of the network, a telephone line, a cable television network, an optical fiber, a satellite, a radio communication and the like may be used.

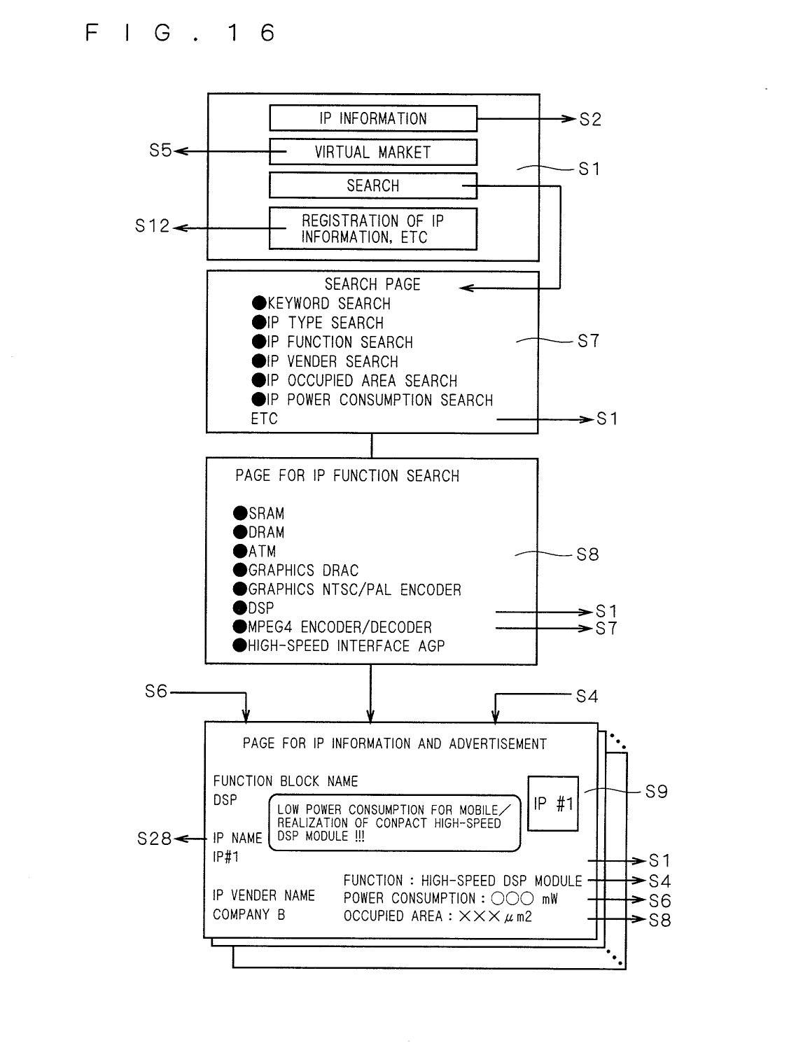

Next, a constitution of the server SV will be discussed, referring to FIG. 15. The server SV includes a CPU (Central Processing Unit) and a RAM (Random Access Memory), a ROM (Read Only Memory) and the like connected to the CPU, and comprises a central control unit CPa for performing control of other units, transfer of data, a variety of computations, temporary storing of data and the like. The central control unit CPa is connected to a program memory unit PF which records programs describing procedures of a variety of processings in the central control unit CPa (a program for displaying a guide screen on the display units of the information terminals, a program for displaying an IP vender which provides the IP having a desired function on the plan view of the semiconductor device, a program for virtual market of the IP, a search program for acquiring the required IP information by text retrieval and the like).

Further, the server SV comprises an input device IN such as a keyboard and a mouse, an output device DP such as a display and a printer, an input control unit IC and an output control unit OC. The input control unit IC controls data inputted from the information terminals TM1 to TM5 connected thereto through the network NT and data inputted from the input device IN. The output control unit OC controls data at the time when the information from the central control unit CPa is outputted to the information terminals TM1 to TM5 and the output device DP.

The server SV further comprises a structure information memory unit CM recording the structure information of the semiconductor device, a character file CF recording display character data and bitmap data such as an icon and an IP information memory unit VF recording the information on the maker of semiconductor device, the information on the IP vender, the function block information, the information on the semiconductor manufacturing apparatus and the like.

Furthermore, as discussed in the first preferred embodiment, the information provider device of the first preferred embodiment can be realized in a form of the server SV of the third preferred embodiment.

Specifically, the structure information discussed in the first preferred embodiment is recorded in the structure information memory unit CM while the information on the maker of semiconductor device, the information on the IP vender, the information on the vender of semiconductor manufacturing apparatus, the function block information (including the information on the IP and the information on the semiconductor manufacturing apparatus) and the like are recorded in the IP information memory unit VF.

More specifically, the structure information memory unit CM records a plan view and a cross section of the semiconductor device, a plan view and a cross section of each function block, a hierarchical structure view of the IP, a pattern layout diagram of the IP and a circuit diagram of the IP, a circuit diagram of the IP in transistor level and the like. The plan view of the semiconductor device has a hierarchical structure, and the upper level corresponds to the plan view of the semiconductor device, the middle level corresponds to the plan view of each function block or the cross section of each function block and the lower level corresponds to the circuit diagram of the IP, the circuit diagram of the IP in transistor level, the pattern layout diagram of the IP and the like. Further, the circuit diagram of the IP, the circuit diagram of the IP in transistor level and the pattern layout diagram of the IP in the lower level may have or may not have a hierarchical structure. Furthermore, the display data format in each level may be a bitmap format, for example.

The IP information memory unit VF has only to record data, e.g., on IP, as file information by IP registration number, as illustrated as registration files RF1 to RFn in FIG. 15. The registration file is made of informations intrinsic in an IP such as an IP registration number given to each IP, information on an IP registrant, a registrant ID, a password, information on the IP, the position and hierarchy (x, y, z) of the registered IP in a chip. Further, (x, y, z) is coordinate information indicating in what level (z) of the plan view or the cross section the position (x, y) of the IP in the plan view of the semiconductor device is located. The IP registration number is a number which is automatically given from the central control unit CPa.

The information intrinsic in the IP includes the IP vender name, the IP product number, the telephone number, the facsimile number and the mail address of the IP vender, the performance and function of the IP, the occupied area of the IP, the advertising message, the link and the like. The link refers to information for access to IP of lower level which is a constituent of the IP or IP of upper level which the IP is a constituent of, or access to the whole semiconductor device. Further, the advertisement information of the third preferred embodiment means an advertising message expressing the advertisement of the IP with text and the like in a narrow sense but means all the informations, upper than the information on the IP, required for making the registration file in a broad sense.

Furthermore, files as to the information on the makers of semiconductor device and the information on the venders of semiconductor manufacturing apparatus are made, like those as to the information on the IP registrants, and recorded in the IP information memory unit VF.

Then, the above various informations are outputted from the central control unit CPa to output devices (the information terminals TM1 to TM5 or the output device DP), for providing information.

Next discussion will be made on an operation of the information provider system of the third preferred embodiment. Herein, the information terminals TM1 to TM5 are each connected to the server SV to make communications, performing functions as information terminals for advertisement clients (e.g., the company A (maker of semiconductor device), the company B (IP vender or vender of semiconductor manufacturing apparatus) and the company C (IP vender or vender of semiconductor manufacturing apparatus) in FIG. 13) and also as the information terminals for advertisement recipients (those read the advertisements provided by the clients). Hereinafter, it is assumed that the information terminal for the advertisement recipient is the information terminal TM1 and the information terminal for the advertisement client is the information terminal TM5, for convenience of discussion.

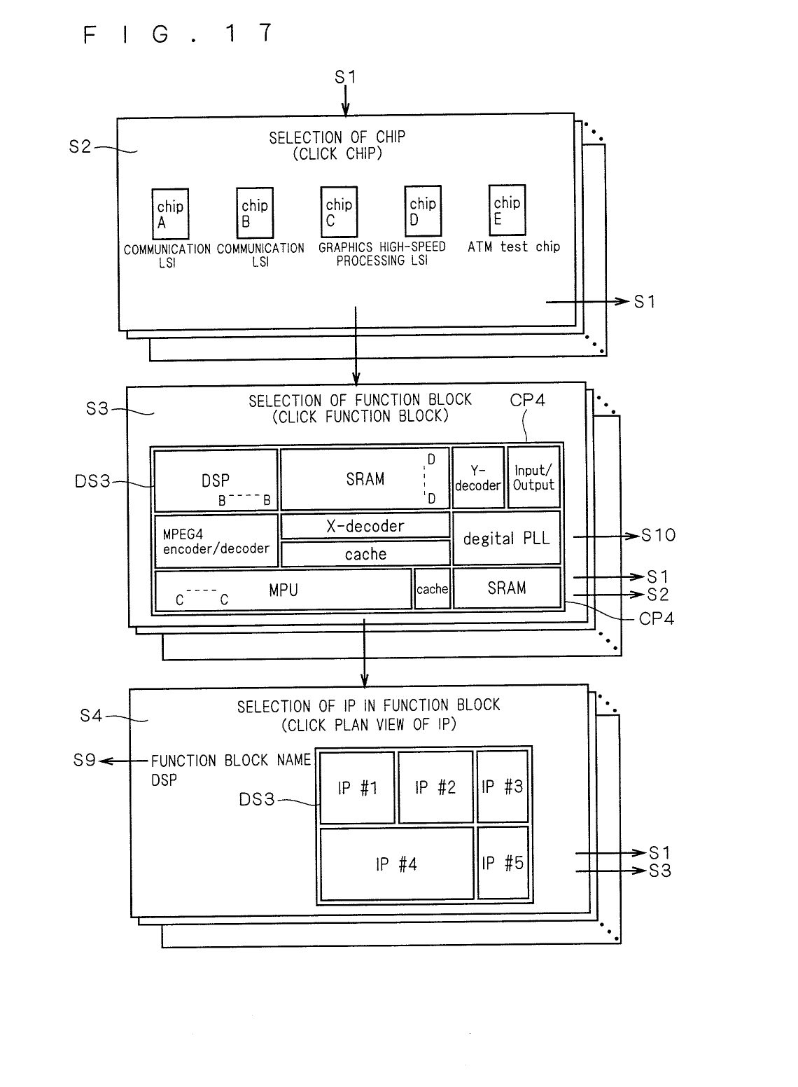

First, when the server SV is connected to the information terminal TM1, the central control unit CPa detects this connection through the input control unit IC and controls the information terminal TM1 on the basis of a program recorded in the program memory unit PF. FIGS. 16 to 25 are schematic views of a procedure of this program, showing contents of screens displayed in respective operations.

In the step S1 of FIG. 16, the central control unit CPa makes the display unit of the information terminal TM1 display a menu as shown in FIG. 16, to prompt an operator of the information terminal TM1 to select a desired processing among the items such as IP information, virtual market of IP, search and registration of IP information, etc. Further, the menu screen is designed so that the operator of the information terminal TM1 can make selection by operating a cursor on the screen with input means such as a mouse.

A. Receiving IP Information and Advertisement

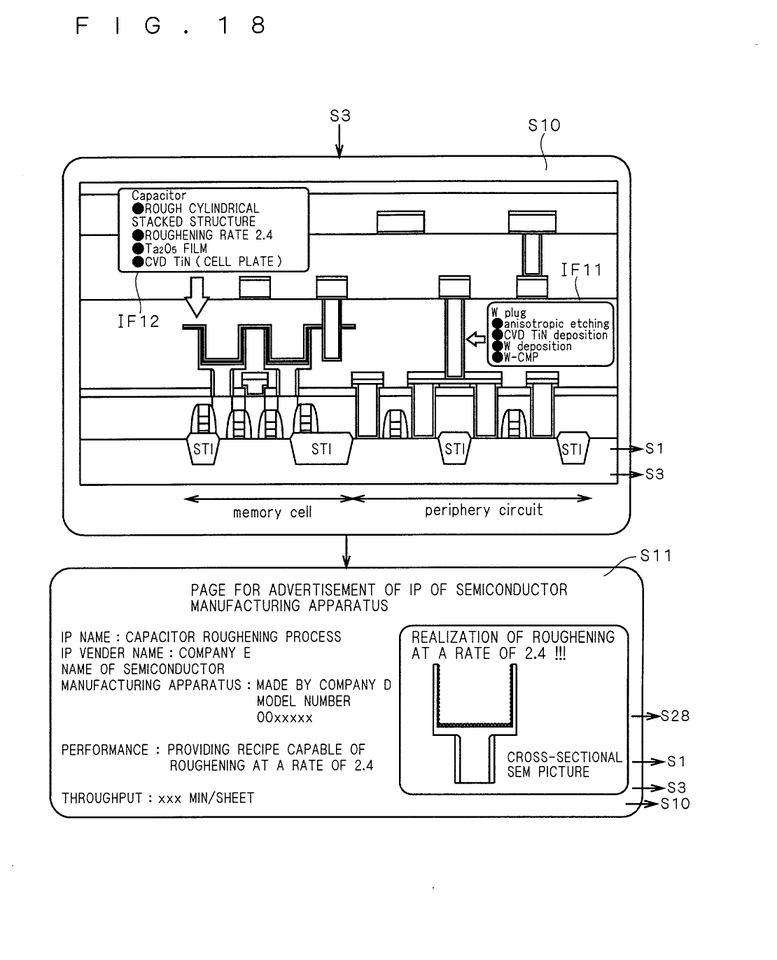

In the step S1, when the IP information is selected, views of various chips of the semiconductor device on which the IP is mounted is displayed on the display unit of the information terminal TM1 as shown in the step S2 of FIG. 17. Further, in the step S2, the arrow to the step S1 indicates that the return to the step S1 from the step S2 is possible. Hereinafter, the arrow in each step indicates the same.

In the step S2, when a desired chip is selected by clicking the mouse and so on, a plan view of the chip is displayed on the display unit of the information terminal TM1, being divided by function blocks, as shown in the step S3. Then, when a desired function block is selected, a plan view of the chip is displayed on the display unit of the information terminal TM1 with the selected function block divided by lower-leveled function blocks, as shown in the step S4. Further, it is assumed herein that the lower-leveled function blocks are made of IPs IP #1 to IP #5.

When a desired IP is selected among the IPs IP #1 to IP #5 by moving the cursor to the desired IP and so on, information on the selected IP and advertisement information are displayed on the display unit of the information terminal TM1, as shown in the step S9 of FIG. 16. Further, these informations are recorded in the IP information memory unit VF in advance in the format like the registration file RF1 discussed above.

Furthermore, as discussed in detail in the first preferred embodiment, when a desired position is selected by clicking the mouse in the view showing each function block, structure informations of the lower-leveled function blocks included in the selected region are displayed in various display forms such as a pattern layout diagram, a circuit diagram and a circuit diagram in transistor level. By moving the cursor on the view of each function block and so on, the function block information of the function block is displayed.

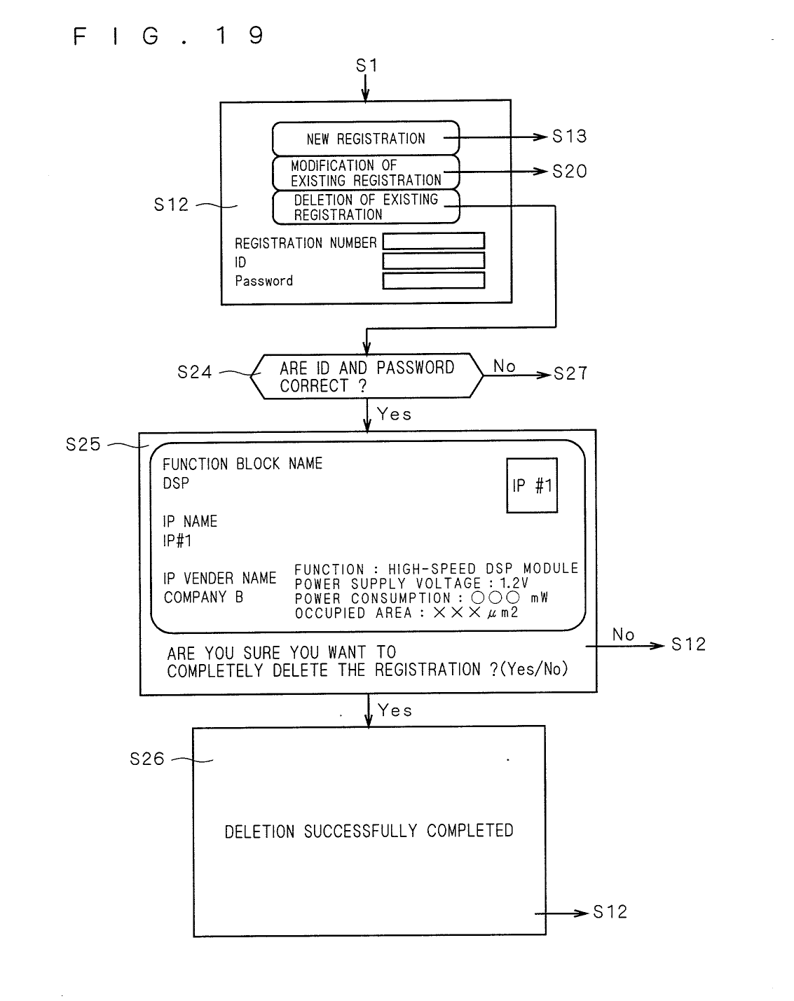

In the step S3, when a desired section line (e.g., D-D and C-C) on the plan view of the chip is selected, a cross section of the chip is displayed on the display unit of the information terminal TM1, as shown in the step S10 of FIG. 18. Then, when required information is selected by moving the cursor to a desired position, an advertisement page of a semiconductor manufacturing apparatus is displayed on the display unit of the information terminal TM1, as shown in the step S11. Further, such advertisement information of the semiconductor manufacturing apparatus is recorded in the IP information memory unit VF in advance like the advertisement information of the IPs.

Furthermore, the advertisement information of the semiconductor manufacturing apparatus may not necessarily be linked only to a cross section, the advertisement information may be linked to a plan view. For example, in a case of a transfer device (e.g., an ArF scanner, an F₂ scanner and an electron beam exposure device) and the like, the advertisement information linked to a plan view is easily grasped by recipients of the information.

The plan view and the cross section of the chip, the plan view and the cross section of each function block and the like are read out from the structure information memory unit CM by the central control unit CPa and outputted to the information terminal TM1, for display.

When the operator of the information terminal TM1 selects a desired position on the plan view or the cross section with the input means such as a mouse, information on the (x, y) coordinate and information on the hierarchical level z are transmitted from the information terminal TM1 to the central control unit CPa through the input control unit IC. The central control unit CPa reads out a plan view, a cross section and circuit diagrams in various display forms corresponding to the (x, y, z) among the informations recorded in the structure information memory unit CM and further reads out the function block information on the selected position among the informations recorded in the IP information memory unit VF. Then, the central control unit CPa outputs these informations linked to each other to the information terminal TM1 through the output control unit OC, such as that the function block information is outputted when the cursor is moved to a view of the structure information.

The IP and the like on the plan view and the like of the function block may be displayed in a form of icon, for example, instead of the bitmap form. In such a case, the information of the icon is recorded in the character file CF and its character information is transmitted from the central control unit CPa to the information terminal TM1. It is designed that when the icon on the information terminal TM1 is selected with the input means such as a mouse, information on the IP or the like represented by the icon can be displayed on the information terminal TM1.

B. Retrieval of IP Information

In the menu screen of the step S1 of FIG. 16, when search is selected, a search page shown in the step S7 is displayed on the display unit of the information terminal TM1. As to the retrieval, it is designed that besides keyword search, various categories such as IP type search, IP function search, IP vender search, IP occupied area search, IP power consumption search should be provided for retrieval. Further, it is designed that AND retrieval, OR retrieval and NOT retrieval of the retrieval items can be made.

The information needed for the retrieval is inputted by the operator of the information TM1 and the retrieval is made by the central control unit CPa, referring to the registration files and the like recorded in the IP information memory unit VF. Then, the central control unit CPa outputs a retrieval result to the information terminal TM1.

For example, when the IP function search is selected in the step S7, retrieval items are displayed by function, as shown in the step S8. Then, when the item, DSP, is selected, for example, a list of IPs on the DSP is displayed, and when one of the listed IPs is further selected, the IP information and the advertisement information on the selected DSP is displayed, as shown in the step S9.

C. New Registration of IP Information and Advertisement

Now, a procedure on registration of IP informations and advertisements from advertisement clients will be discussed, using the information terminal TM5 for the advertisement clients.

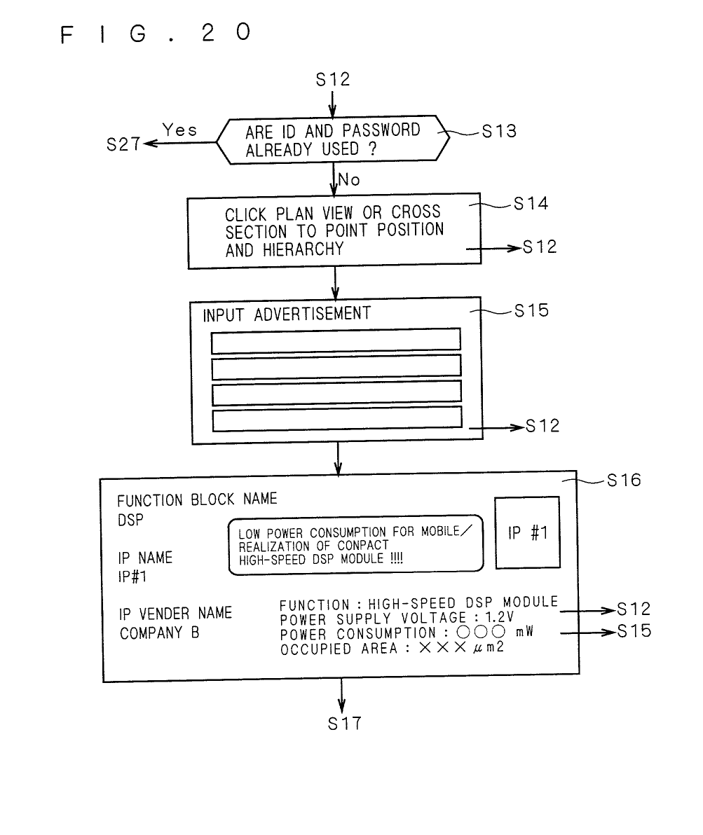

In the menu screen of the step S1 of FIG. 16, when the item, registration of IP information, etc, is selected, a registration page shown in the step S12 of FIG. 19 is displayed on the display unit of the information terminal TM5. In this registration page, inputting of the registration number, the registrant ID and the password is prompted. On new registration, the operator of the information terminal TM5 can input any registration number, registrant ID and password. Then, the operator of the information terminal TM5 selects the item, new registration, among the options with the input means such as a mouse.

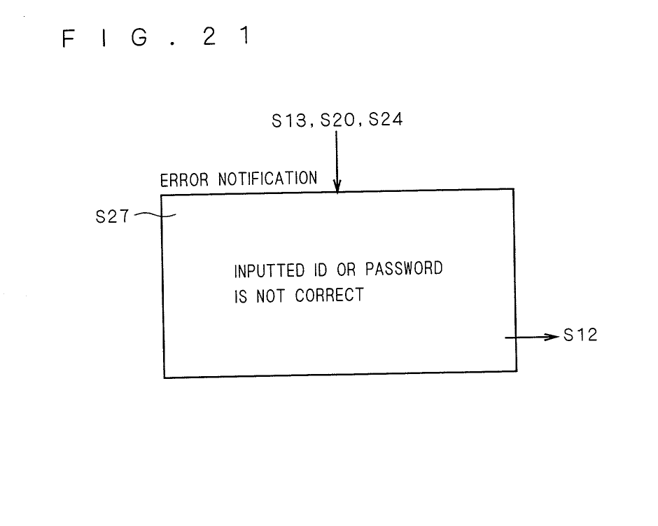

In this case, in order to avoid duplicate registration, the central control unit CPa judges whether the inputted registrant ID and password are already used or not, referring to the registration files and the like recorded in the IP information memory unit VF, as shown in the step S13 of FIG. 20.

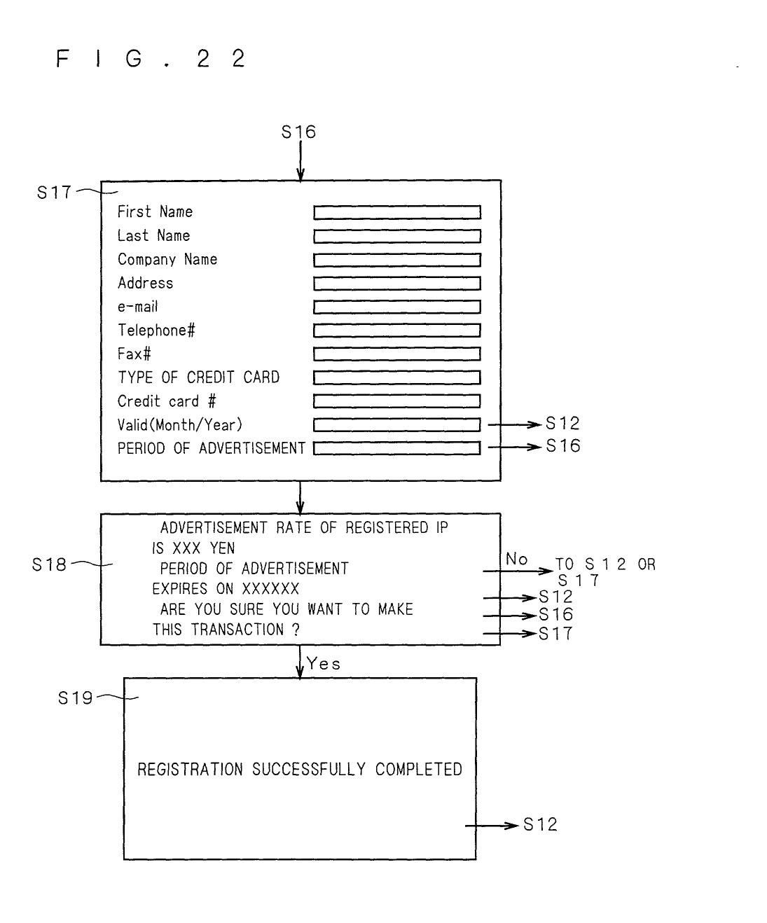

If the inputted registrant ID and password are already used, the process goes to the step S27 of FIG. 21 and the central control unit CPa notifies the information terminal TM5 that the inputted registrant ID and password are not correct. Then, back to the step S12, the registration menu screen is displayed again.

On the other hand, if the inputted registrant ID and password are not already used, the process goes to the step S14 of FIG. 20 and the central control unit CPa prompts the operator of the information terminal TM5 to point a position to which the IP information and the advertisement are to be linked by clicking the mouse on the plan view or cross section of the chip or the upper IP. The displayed plan view or cross section are graphical information recorded in the structure information memory unit CM.

Next, the process goes to the step S15 of FIG. 20 and the central control unit CPa prompts the operator of the information terminal TM5 to input the IP information and the advertisement to be displayed.

Further, the operator of the information terminal TM5 makes the IP information and the advertisement in a predetermined file format in advance, and makes associated information (e.g., a plan view, a pattern layout diagram and the like of the IP) as another file and links this information to the file such as the advertisement. Then, the operator inputs the file name in a specified field.

Next, the process goes to the step S16 of FIG. 20 and the central control unit CPa prompts the operator of the information terminal TM5 to check if the IP information and the advertisement to be displayed is correctly displayed.

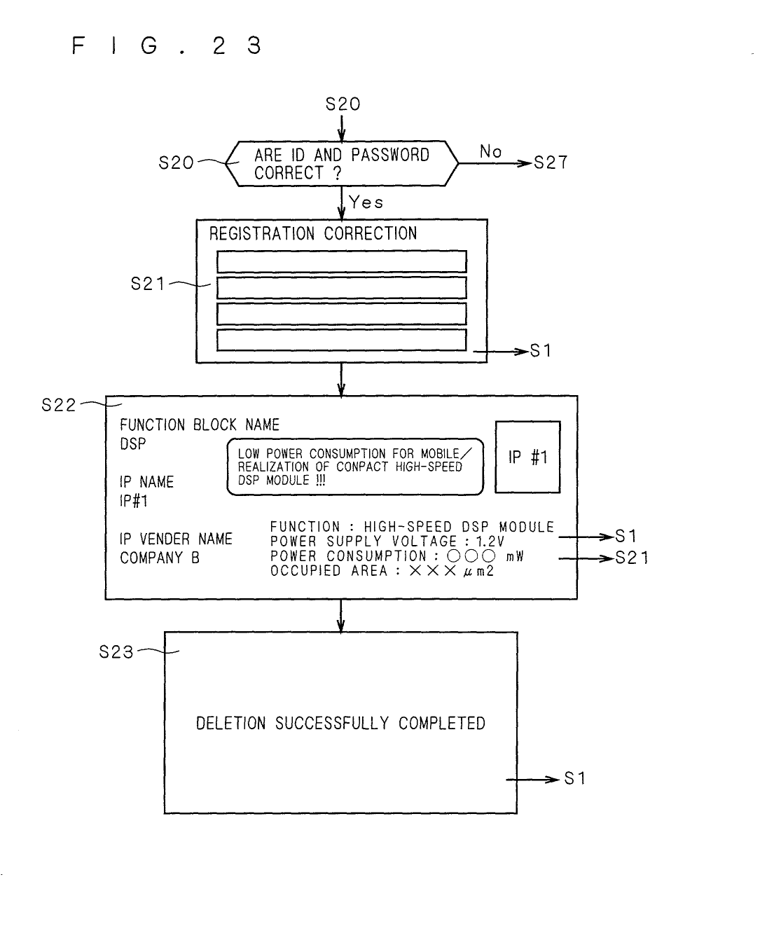

If the displayed contents are right, the process goes to the step S17 of FIG. 22 and the central control unit CPa displays a page for electronic commerce on advertising contract. In the page for electronic commerce in the step S17, the operator of the information terminal TM5 inputs items such as the IP registrant name, the company name, the address, the mail address, the telephone number, the facsimile number, the type of credit card, the number of credit card, the valid period of credit card and the period of advertisement.

After the input of these items, in the step S18, the central control unit CPa calculates the advertising expenditure for the registered IP according to a predetermined rule (recorded in, e.g., the program memory unit PF) and displays the advertising expenditure on the display unit of the information terminal TM5.

If the operator of the information terminal TM5 agrees the contents of the electronic commerce, the operator notifies agreement to the central control unit CPa. Then, the inputted IP information and the advertisement information are transmitted to the central control unit CPa and recorded as a registration file in the IP information memory unit VF. Further, information requesting the transaction needed to settle the advertising expenditure is sent to a credit card company, a bank or the like. If the operator does not agree, the process goes back to the step S17 or the step S12.

At the stage of completing all the processing, the process goes back to the step S19, and the central control unit CPa notifies the information terminal TM5 that the registration is completed.

Though a case of credit card has been discussed as an example of settlement of the electronic commerce in the step S17, electronic commerce means such as electronic money (cash), electronic check and debit card, which allows financial settlement, may be used.

Further, when the period of advertisement approaches an end, the central control unit CPa notifies the information terminal TM5 which is the registrant of the IP that the period of advertisement approaches an end to prompt recontract of the advertisement. The advertisement client can notify the advertising agency operating the server SV by E-mail and the like from the information terminal TM5 as to whether the advertisement contract is renewed or not. If the advertisement client does not renew the contract, the central control unit CPa stops displaying the advertisement after the period of advertisement.

D. Modification of Existing Registration on IP Information and Advertisement

The procedure on registration of IP informations and advertisements from advertisement clients will be also discussed herein, using the information terminal TM5 for the advertisement clients.

In the menu screen of the step S1 of FIG. 16, when the item, registration of IP information, etc, is selected, a registration page shown in the step S12 of FIG. 19 is displayed on the display unit of the information terminal TM5. In this registration page, inputting of the registration number, the registrant ID and the password is prompted. On modification of existing registration, the operator of the information terminal TM5 inputs the given registration number, registrant ID and password. Then, the operator of the information terminal TM5 selects the item, modification of existing registration, among the options with the input means such as a mouse.

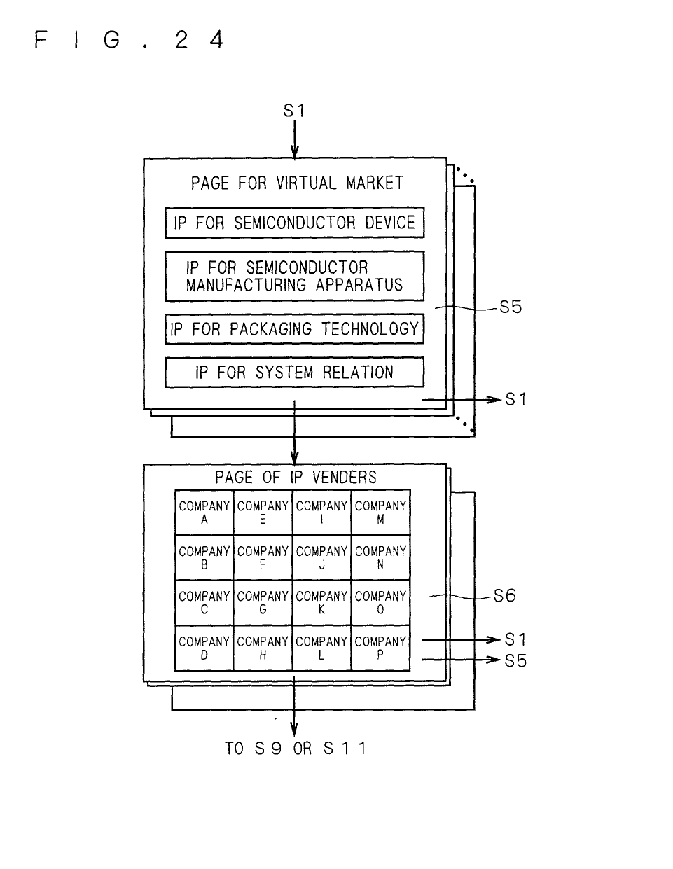

In this case, the central control unit CPa judges whether the inputted registrant ID and password are correct or not, referring to the registration files and the like recorded in the IP information memory unit VF, as shown in the step S20 of FIG. 23.

If it is judged that the inputted registrant ID and password are not correct, the process goes to the step S27 of FIG. 21 and the central control unit CPa notifies the information terminal TM5 that the inputted registrant ID and password are not correct. Then, back to the step S12, the registration menu screen is displayed again.

On the other hand, if it is judged that the inputted registrant ID and password are correct, the process goes to the step S21 of FIG. 23 and the central control unit CPa prompts the operator of the information terminal TM5 to correct the registered contents.

Next, the process goes to the step S22 and the central control unit CPa prompts the operator of the information terminal TM5 to check if the screen of the IP information and the advertisement to be displayed is correctly displayed.

If the displayed contents are right, the operator of the information terminal TM5 notifies the central control unit CPa that the contents are right. Then, the corrected IP information and the advertisement information are transmitted to the central control unit CPa and the contents of the registration file in the IP information memory unit VF are updated. Further if the operator notified the central control unit CPa that the displayed contents are wrong, the process goes back to the step S21 or S1.

At the stage of completing all the processing, the process goes back to the step S23, and the central control unit CPa notifies the information terminal TM5 that the modification is completed.

E. Deletion of Existing Registration on IP Information and Advertisement

The procedure on registration of IP informations and advertisements from advertisement clients will be also discussed herein, using the information terminal TM5 for the advertisement clients.

In the menu screen of the step S1 of FIG. 16, when the item, registration of IP information, etc, is selected, a registration page shown in the step S12 of FIG. 19 is displayed on the display unit of the information terminal TM5. In this registration page, inputting of the registration number, the registrant ID and the password is prompted. Also on deletion of existing registration, the operator of the information terminal TM5 inputs the given registration number, registrant ID and password. Then, the operator of the information terminal TM5 selects the item, deletion of existing registration, among the options with the input means such as a mouse.

In this case, the central control unit CPa judges whether the inputted registrant ID and password are correct or not, referring to the registration files and the like recorded in the IP information memory unit VF, as shown in the step S24 of FIG. 19.

If it is judged that the inputted registrant ID and password are not correct, the process goes to the step S27 of FIG. 21 and the central control unit CPa notifies the information terminal TM5 that the inputted registrant ID and password are not correct. Then, back to the step S12, the registration menu screen is displayed again.

On the other hand, if it is judged that the inputted registrant ID and password are correct, the process goes to the step S25 of FIG. 19 and the central control unit CPa prompts the operator of the information terminal TM5 to select the registered contents to be deleted. Further, the central control unit CPa prompts the operator of the information terminal TM5 to check if the screen of the IP information and the advertisement to be deleted is correctly displayed.

If the displayed contents can be deleted, the operator of the information terminal TM5 notifies the central control unit CPa that the displayed contents can be deleted. The central control unit CPa, receiving the notification, deletes the contents of the registration file in the IP information memory unit VF. If the operator notifies the central control unit CPa that the displayed contents can not be deleted, the process goes back to the step S12.

At the stage of completing all the processing, the process goes back to the step S26, and the central control unit CPa notifies the information terminal TM5 that the deletion is completed.

F. Purchase of IP Information (Virtual Market)

A procedure on purchase of IP informations by the advertisement recipients will be discussed herein, using the information terminal TM1 for the advertisement recipients.

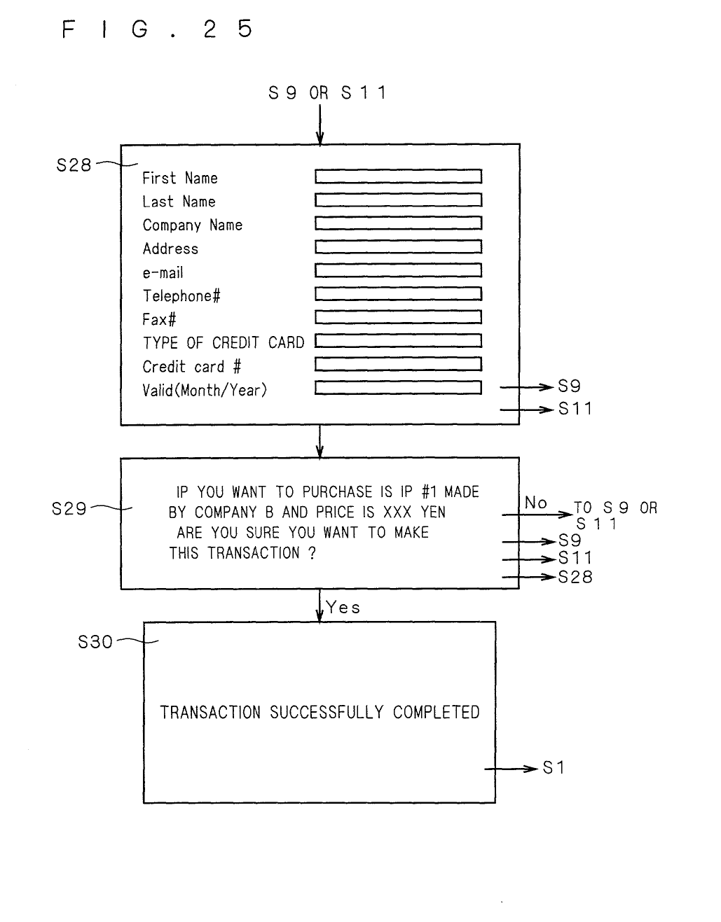

In the menu screen of the step S1 of FIG. 16, when the item, virtual market, is selected, a page for virtual market shown in the step S5 of FIG. 24 is displayed on the display unit of the information terminal TM1. In this page for virtual market, various types of IPs and semiconductor manufacturing apparatus such as IP for semiconductor device (various function blocks), IP for semiconductor manufacturing apparatus (various semiconductor manufacturing apparatus or various recipes of semiconductor manufacturing apparatus), IP for packaging technology (function blocks, semiconductor manufacturing apparatus and recipes of semiconductor manufacturing apparatus on the packaging technology) and IP for system relation (function blocks on the system relation) are displayed.

When the operator of the information terminal TM1 selects a desired IP with the input device such as a mouse, the process goes to the step S6 and a page showing a list of IP venders and venders of semiconductor manufacturing apparatus is displayed. When, the operator of the information terminal TM1 selects a desired company with the input device such as a mouse, the process goes to the step S9 or S11 and information and advertisement on the IPs or semiconductor manufacturing apparatus sold by the company are displayed.

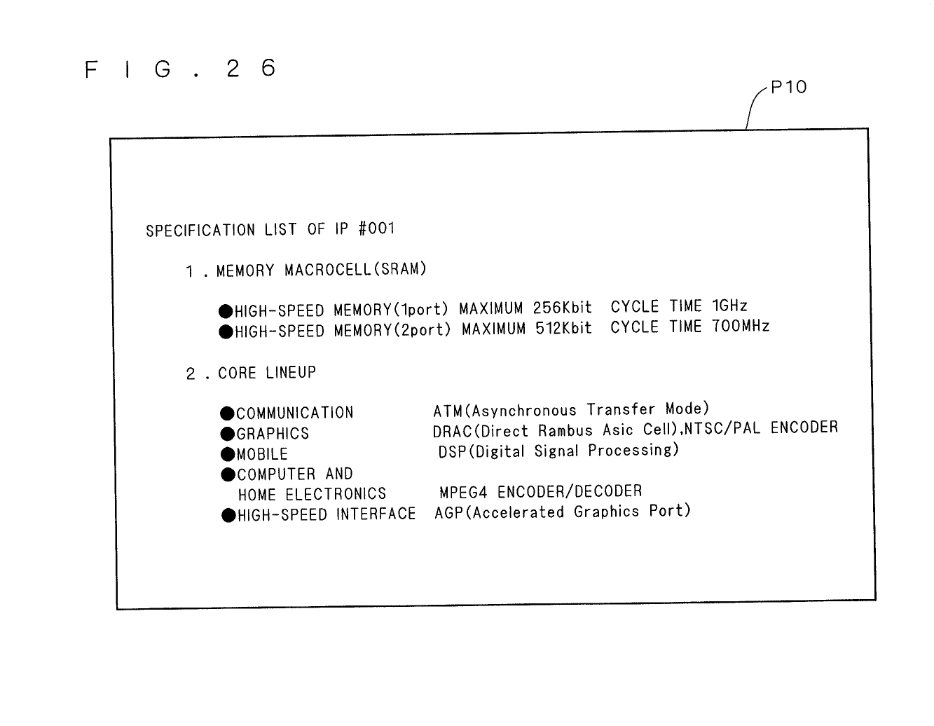

In the step S9 of FIG. 16 or the step S11 of FIG. 18, if the advertisement recipient intends to buy the IP of the function block in the semiconductor circuit, the semiconductor manufacturing apparatus itself or the IP of the recipe of the semiconductor manufacturing apparatus, the process goes to the step S28 of FIG. 25 from the step S9 or S11.

Then, the central control unit CPa displays a page for electronic commerce on purchasing contract. In the page for electronic commerce in the step S28, the operator of the information terminal TM1 inputs items such as the purchaser's name, the company name, the address, the mail address, the telephone number, the facsimile number, the type of credit card, the number of credit card and the valid period of credit card.

After the input of these items, in the step S29, the central control unit CPa confirms particulars of the purchase (the model number, the price and the like of the IP to be purchased).

If the operator of the information terminal TM1 agrees the contents of the electronic commerce, the operator notifies agreement to the central control unit CPa. Then, the central control unit CPa sends information requesting the transaction needed to settle the purchasing contract to a credit card company, a bank or the like. At this time, whether payable or not is checked and if payable, the central control unit CPa permits the information terminal TM1 to download the software of the IP of the function block and the software on the recipe of the semiconductor manufacturing apparatus. If the operator does not agree, the process goes back to the step S9 or the step S11.

At the stage of completing all the processing, the process goes to the step S30, and the central control unit CPa notifies the information terminal TM1 that the dealing is completed.

Though a case of credit card has been discussed as an example of settlement of the electronic commerce in the step S28, electronic commerce means such as electronic money (cash), electronic check and debit card, which allows financial settlement, may be used.

Thus, as the central control unit of the server SV outputs the whole or part of structure information to the information terminal TM1 and outputs the information on the IP of the function block and semiconductor manufacturing apparatus linked to the whole or part of structure information to the information terminal TM1 on request from the information terminal TM1, it is possible to display the views on the structure of the semiconductor device and the information on the IP of the function block and the semiconductor manufacturing apparatus on the information terminal TM1 on request from the operator of the information terminal TM1. Therefore, an information provider system which allows easy grasp of relation between the structure of the semiconductor device and the information on the IP and the semiconductor manufacturing apparatus for the operator of the information terminal TM1 can be obtained.

Further, when the server SV conducts electronic commerce of the IP on the function block information, the semiconductor manufacturing apparatus or the recipe of the semiconductor manufacturing apparatus with the information terminal TM1, it is possible to easily conduct the dealing of the IP on function block information, the semiconductor manufacturing apparatus or the recipe of the semiconductor manufacturing apparatus.

Furthermore, when the information terminal TM1 downloads the software of the IP on the function block information from the server SV in the electronic commerce, it is possible to easily incorporate the software in a program on design of the semiconductor device made on the side of the information terminal TM1.

When the information terminal TM1 downloads the software of the recipe of the semiconductor manufacturing apparatus from the server SV in the electronic commerce, it is possible to easily incorporate the software in a control program of the semiconductor manufacturing apparatus owned on the side of the information terminal TM1.

When the central control unit CPa retrieves the information on the IP and the information on the semiconductor manufacturing apparatus with reference to the recorded contents in the IP information memory unit VF on the basis of information transmitted from the information terminal TM1, the operator of the information terminal TM1 can access desired information on the IP and information on the semiconductor manufacturing apparatus.

Further, since the information on the IP and the information on the semiconductor manufacturing apparatus in the structure information memory unit CM is recorded on the basis of the information transmitted from the information terminal TM5 and the central control unit CPa modifies or deletes the information on the IP and the information on the semiconductor manufacturing apparatus on request from the information terminal TM5, the operator of the information terminal TM5 can easily register, modify and delete the informations on his own IP and semiconductor manufacturing apparatus.

Furthermore, when the information on the IP and the information on the semiconductor manufacturing apparatus include the information on the advertisements therefor, it is possible to display the views on the structure of the semiconductor device and the advertisement informations on the IP and the semiconductor manufacturing apparatus linked to each other on the output device. Therefore, an information provider system which allows a highly effective advertisement on the IP and the semiconductor manufacturing apparatus can be obtained.

When the server SV is used as an information provider device of standalone type, transmission of informations are performed through the input device IN and the output device DP. Specifically, the operator can read, register, modify, delete, retrieve and purchase the information by operating the input device IN while the information from the central control unit CPa is outputted on the output device DP.

While the invention has been shown and described in detail, the foregoing description is in all aspects illustrative and not restrictive. It is therefore understood that numerous modifications and variations can be devised without departing from the scope of the invention.

What is claimed is:

1. An information provider device, comprising:
memory means for recording structure information which is information of view on a structure of a semiconductor device in which at least one function block as a circuit block having a predetermined function is formed and function block information which is information on said function block; and
control means for reading said structure information and said function block information out from said memory means and outputting these informations linked to each other.

2. The information provider device according to claim 1, wherein
said function block information includes information on intellectual property of said function block.

3. The information provider device according to claim 2, wherein
said function block information further includes information on advertisement of said intellectual property.

4. The information provider device according to claim 1, wherein
said structure information includes information on constituent elements constituting said semiconductor device,
said function block information includes information on semiconductor manufacturing apparatus used for manufacturing said constituent elements, and
said control means reads said structure information and said information on semiconductor manufacturing apparatus out from said memory means and outputs these informations linked to each other.

5. The information provider device according to claim 4, wherein
said information on semiconductor manufacturing apparatus includes information on advertisement of said semiconductor manufacturing apparatus.

6. The information provider device according to claim 1, wherein
said function block and said function block information each have hierarchical structure.

7. The information provider device according to claim 6, wherein
said function block information includes information on intellectual property of said function block or information on semiconductor manufacturing apparatus used for manufacturing constituent elements constituting said semiconductor device and information on advertisement of said intellectual property or said semiconductor manufacturing apparatus, and
holders of said intellectual property in respective levels of said hierarchical structure or venders of said semiconductor manufacturing apparatus in respective levels of said hierarchical structure are different from one another.

8. An information provider system, comprising:
said information provider device defined as defined in claim 1; and
a first information terminal connectable to said information provider device through a network,
wherein said control means outputs the whole or part of said structure information to said first information terminal and outputs said function block information linked to the whole or part of said structure information to said first information terminal on request from said first information terminal.

9. The information provider system according to claim 8, wherein
said function block information includes information on intellectual property of said function block,
said information provider device and said first information terminal each have electronic commerce function, and
said information provider device conducts electronic commerce of intellectual property on said function block information with said first information terminal.

10. The information provider system according to claim 9, wherein
said first information terminal downloads software out of intellectual property on said function block information from said information provider device in said electronic commerce.

11. The information provider system according to claim 8, wherein
said function block information includes information on semiconductor manufacturing apparatus used for manufacturing said constituent elements constituting said semiconductor device,
said information provider device and said first information terminal each have electronic commerce function, and
said information provider device conducts electronic commerce of said semiconductor manufacturing apparatus or information on said semiconductor manufacturing apparatus with said first information terminal.

12. The information provider system according to claim 11, wherein
said first information terminal downloads software on control of said semiconductor manufacturing apparatus out of information on said semiconductor manufacturing apparatus from said information provider device in said electronic commerce.

13. The information provider system according to claim 8, wherein
said control means retrieves said function block information with reference to recorded contents in said memory means on the basis of information transmitted from said first information terminal.

14. The information provider system according to claim 8, further comprising:
a second information terminal connectable to said information provider device through a network,
wherein said function block information in said memory means is recorded on the basis of information transmitted from said second information terminal, and
said control means modifies or deletes said function block information on request from said second information terminal.

15. An advertising method for making an advertisement using said information provider device as defined in claim 1, wherein
said function block information includes information on intellectual property of said function block or information on semiconductor manufacturing apparatus used for manufacturing constituent elements constituting said semiconductor device, and
said advertising method comprising the step of
making an advertisement with said function block information including information on advertisement of said intellectual property or said semiconductor manufacturing apparatus.

16. The advertising method according to claim 15, wherein
said function block and said function block information each have hierarchical structure, and
holders of said intellectual property in respective levels of said hierarchical structure or venders of said semiconductor manufacturing apparatus in respective levels of said hierarchical structure are different from one another.

17. The advertising method according to claim 15, wherein
said advertisement using said information provider device is made by a third party.
